(19) United States
(12) Patent Application Publication
(10) Pub. No.: US 2006/0088138 A1
(43) Pub. Date: Apr. 27, 2006

(54) Method and apparatus for the generation and the utilization of plasma solid

(76) Inventor: Andre Jouanneau, Bethesda, MD (US)

Correspondence Address: BERENATO, WHITE & STAVISH, LLC, 6550 ROCK SPRING DRIVE, SUITE 240, BETHESDA, MD, 20817, US

(21) Appl. No.: 11/004,233

(22) Filed: Dec. 6, 2004

Related U.S. Application Data
(60) Provisional application No. 60/560,012, filed on Apr. 7, 2004.

(51) Int. Cl. G21B 1/25

(52) U.S. Cl. 376/131

(57) ABSTRACT

A method and apparatus for producing stable plasma inside a solid are provided. According to an embodiment of the method, a source of ionic particles is provided, the source being selected from an ionic solution having a pH less than 1.0, plasma gas, and a gas atmosphere. A direct electrical current is applied to a solid, and the ionic particles from the source of ionic particles are introduced into the solid to form plasma. Periodic impulses are applied to the solid to vibrate the solid and stabilize the plasma.

### RELATED APPLICATION

This application claims the benefit of priority of provisional application 60/560,012 entitled “Method and Apparatus for the Generation and the Utilization of Plasma Solid”, filed Apr. 7, 2004, the complete disclosure of which is incorporated herein by reference.

### BACKGROUND OF THE INVENTION

1. Field of the Invention

This invention generally relates to the storage and production of energy, plasma physics, and nuclear fusion. In particularly preferred embodiments of the invention, methods and apparatus are provided that enable the storage of large quantities of positive hydrogen ions H⁺, D⁺, T⁺ in the form of very high density stable plasma inside a solid (also referred to herein as plasma solid). Plasma solid has many potential uses, including, for example, storage of large quantities of energy in plasma form, production of energy through nuclear fusion, generation of particles, and transmutation.

2. Description of the Related Art

Since the 1950's, scientists have been trying to discover a source of plentiful, clean and cheap usable energy. The best hope to date is hydrogen. This element can be extracted from water through electrochemical methods, thermochemical processes and various other means. The recombination of hydrogen with oxygen produces molecules of water and clean energy. This recombination can be accomplished through combustion or through an electrochemical process inside a fuel cell. However, to maximize return on investment, it is advisable to increase the density of hydrogen per unit of volume. This can be accomplished by compressing hydrogen under high pressure or by using hydrogen in its liquid form. Because of its nature as a plasma of particles, the plasma solid described herein has the advantage not only of having a larger particle density than liquid hydrogen, but also a much greater energetic density.

Because there are no high efficiency, high capacity means to store electricity, the power supply on an electric grid is matched to demand at all times to prevent blackout. If, however, energy could be widely stored in a distributed fashion, and released cheaply and efficiently when needed, the reliability and security of the power grid would be increased tremendously. A significant proportion of the electricity produced by eco-friendly methods (e.g., wind, sun power, sea waves energy) is often wasted because the production frequently reaches the grid when the energy is not needed or when the energy cannot be safely distributed. If, instead, that wasted energy could be stored, the energy could then be converted back and distributed where and when the energy is needed on the grid. The plasma solid of embodiments of this invention constitutes a means to store large quantities of high density energy cheaply and efficiently. This energy can then be easily released and distributed into the grid.

Likewise, over the last decades, physicists have undertaken a massive effort to produce electric power through controlled nuclear fusion. Deuterium, which represents 0.015% of the hydrogen on earth, can be used as a fuel for nuclear fusion. Scientific research has been focused on the field of controlled high temperature plasma. High temperature plasmas are controlled through different means, including magnetic confinement of the plasma as in the case of the tokamak; a conventional mirror; a tandem mirror; or inertial confinement fusion by lasers or beams of protons. Despite massive investments in these very sophisticated apparatus, none of these methods have produced the excess of energy needed to sustain a continuous process of nuclear fusion.

In 1989, Pons and Fleischman presented a new method to produce nuclear fusion (cold fusion) by compressing a large quantity of deuterium atoms inside palladium. But the pressure required to fuse deuterium atoms inside the cathode is superior to the pressure found at the center of Jupiter. This build up of pressure is impossible to create inside palladium without destroying the cathode. No reproducible results have been obtained through this method.

### SUMMARY OF THE PRESENT INVENTION

In accordance with the purposes of the invention as embodied and broadly described in this document, an aspect of the invention provides a method of producing a stable plasma inside a solid. The method of this aspect comprising providing a source of ionic particles selected from an ionic solution having a pH less than 1.0, plasma gas, and/or a gas atmosphere. A direct electrical current is applied through a support to a solid supported on the support. Ionic particles from the source of ionic particles are introduced into the solid to form a plasma, and periodic impulses are applied to the solid to vibrate the solid and stabilize the plasma.

Another aspect of the invention provides an apparatus for producing a stable plasma. The apparatus of this aspect comprises a solid material constructed to permit the creation of stable plasma therein, and a source of ionic particles selected from an ionic solution having a pH less than 1.0, plasma gas, and/or a gas atmosphere. The apparatus further comprises means for applying a direct electrical current to a solid, and means for applying periodic impulses to the solid to vibrate the solid and stabilize the plasma.

Still another aspect of the invention provides a method of producing a stable plasma in a solid and using the plasma. The method of this aspect comprises providing a source of ionic particles selected from the group consisting of an ionic solution having a pH less than 1.0, plasma gas, and a gas atmosphere; applying a direct electrical current to a solid; introducing the ionic particles from the source of ionic particles into the solid to form a plasma; applying periodic impulses to the solid to vibrate the solid and stabilize the plasma; and using the plasma.

Certain aspects of the present invention provide methods and apparatus that allow the creation of a high density plasma of protons, deuterons or tritons. These three particles will be noted symbolically as H D T⁺to simplify later notation. This plasma preferably has a very high density (10²² to 10²¹ particles/cm³ or 10²³ to 10²⁴ particles/cm³). By comparison, plasma gases created classically under magnetic confinement only reach densities of about 10¹⁴ particles/cm³. Even though this plasma of H D T⁺ of preferred embodiments is highly concentrated, the plasma is stable and can be maintained without significant difficulty. The plasma itself is produced inside a solid material from an ionic solution, plasma gas, and/or gas atmosphere. Because of the large concentration of the particles and the vibrations, which prevent the association of the positive particles and the electrons, the plasma inside a solid, also referred to herein as a plasma solid, remains stable.

Plasmas of such densities can serve many purposes according to certain aspects of the invention. For example, the storage of hydrogen isotopes in plasma form allows for the storage of more hydrogen H D T⁺ particles per unit of volume than liquid hydrogen, and therefore has a greater potential energy. According to an embodiment of the invention, the H D T⁺ particles released from the solid are used as a source of energy to fuel engines and turbines. According to another embodiment, protons and/or deuterons released as charged particles (H⁺, D⁺) are accelerated and used to propel a rocket in space. According to still another embodiment of the invention, high density plasma inside the metal is used to provoke nuclear fusion reaction between the H D T⁺ particles. The heat produced by these thermonuclear reactions can be used, among other purposes, for domestic heating, to desalinize sea water (e.g., as a source of cheap, potable water, especially for dry countries which borders oceans), to produce cheap electricity, and other uses. Nuclear physics applications are also possible. Several different by-products can be obtained during the plasma-solid fusion: particles such as neutrons, gamma particles, tritium, helium 3, etc. Interactions between the H D T⁺ and the nuclei of metallic atoms are also possible and produce transmutation reaction of the atoms of the solid in accordance with another embodiment.

### BRIEF DESCRIPTIONS OF THE DRAWINGS

The accompanying drawings are incorporated in and constitute a part of the specification. The drawings, together with the general description given above and the detailed description of the preferred embodiments and preferred methods given below, serve to explain the principles of the invention. In such drawings:

FIG. 1 shows an electrolytic bath for the loading of plasma in a solid;

FIG. 2 represents the electrochemical mechanism of hydrogen inside a cathode;

FIG. 3 represents a diagram of potential as a function of Log i;

FIG. 4 illustrates the relationship between Log i₀ and the volume apparent Vₐ for different metals;

FIG. 5a shows the potential as a function of Log i for the palladium in acid solution;

FIG. 5b represents the curve V=f(Log i) for palladium, with smooth and ruptured palladium electrodes;

FIG. 6a shows an elementary energy cell inside palladium;

FIG. 6b is an elementary plasma cell inside palladium;

FIGS. 7a and 7b each represent an apparatus for the addition of both direct and modulated current to provoke vibrations of the cathode at one of its resonance frequencies;

FIG. 8 represents different possible shapes of the cathode and different systems for the sustentation of the cathodes;

FIGS. 9a and 9b show two self-exciting systems that provoke vibrations of the cathode at one of its resonance frequencies;

FIGS. 10a and 10b represent two vibration generators with a magnet or electromagnet to induce vibration of the cathode;

FIG. 11 depicts another vibration generator for the cathode;

FIG. 12 shows a diagram of a metal-plasma gas interface;

FIG. 13 represents a top view of a metal-hydrogen gas interface;

FIG. 14a depicts a system for the creation and release of plasma solid with an ionic solution-metal-plasma gas interface;

FIG. 14b shows another system for the creation and release of plasma with another mixed ionic solution-metal-plasma gas interface;

FIG. 15a illustrates a top view of a mixed interface usable in a vehicle;

FIG. 15b represents a system for the loading, releasing, and using plasma solid as a source of energy in a vehicle;

FIG. 16a shows a system for the release of plasma solid usable to propel a rocket;

FIG. 16b is a cross section of a rocket propelled using plasma solid;

FIG. 17a depicts an elementary plasma cell with its plasma crown or nanotokamak;

FIG. 17b depicts the orbital surrounding the plasma crown inside an elementary plasma cell;

FIG. 18 represents a cross section of a tri-dimensional network of cathodes in a plasma fusion reactor; and

FIG. 19 depicts a cross section of an apparatus designed to discharge an energy wave inside a cathode loaded with plasma solid.

### DETAILED DESCRIPTION OF PREFERRED EMBODIMENT AND PREFERRED METHODS OF THE INVENTION

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

It is to be noted that, as used in the specification and the appended claims, the singular forms “a,” “an,” and “the” include plural referents unless the context clearly dictates otherwise.

I. Solid and Nature of Plasma Creation

According to embodiments of the invention, plasma can be created inside metallic materials from an ionic solution, a plasma gas, or a gas atmosphere. In the case of an ionic solution, the method is electrochemical. The H D T⁺, submitted to an electrical field, penetrate inside the solid.

I.A. Electrochemical Mechanism of Hydrogen Production

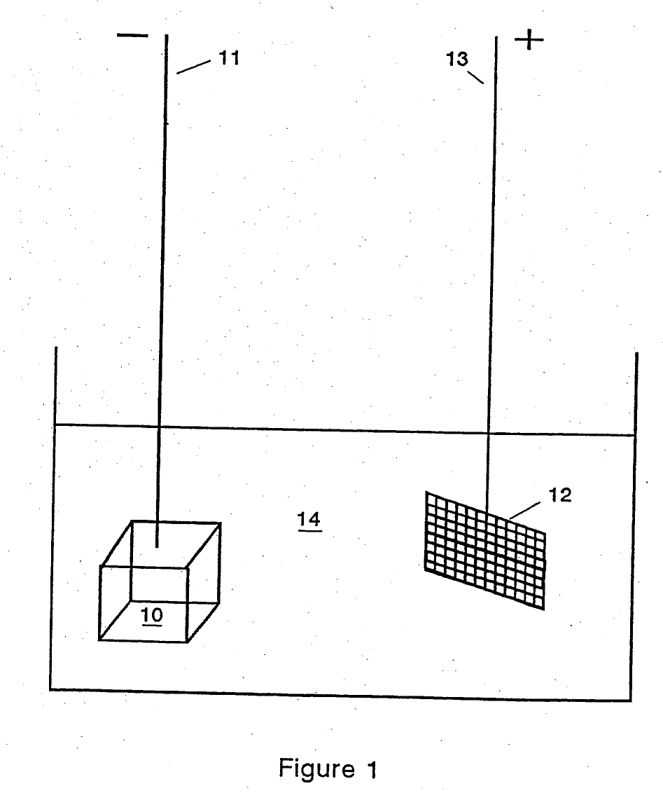

FIG. 1 depicts an electrolytic bath with a cathode (10) made of an electrical conductor, a negative pole (11) of a direct current source, an anode (12) made of platinum or another noble metal, or other materials unimpeachable in anodic conditions, and a positive pole (13) of the source. The electrolyte (14) is an ionic solution with an acid pH in water (H₂O) or heavy water such as D₂O or T₂O.

The decomposition of water through electrolysis was observed and described first by Troostwyk and Deiman [1] in 1789. At that time the only electrical generators were either static or frictional providing high voltage and low amperage, but not continuous current. Volta's discovery of the battery in 1800 remedied this glaring need. One month after Volta's publication, Carlisle and Nicholson [2] published the results of the electrolysis of water using different solutions and electrodes. Since then, thousands of scientists have shown that many factors influence the hydrogen evolution reaction. It has been well known for years that any metal, alloy or other electrical conductor may function as the cathode of an electrolytic apparatus. It is also well known that such a cathode will attract positively charged particles in the bath, such as H D T⁺ and positively charged ions. It has generally been believed that the H D T⁺ attracted to the cathode remained at the outer surface of the cathode to produce molecular hydrogen according to the electrochemical mechanism:
H⁺+e⁻→H+13.5 eV (first electrochemical step)
H+H⁺+e⁻→H₂+17.8 eV (second electrochemical step)

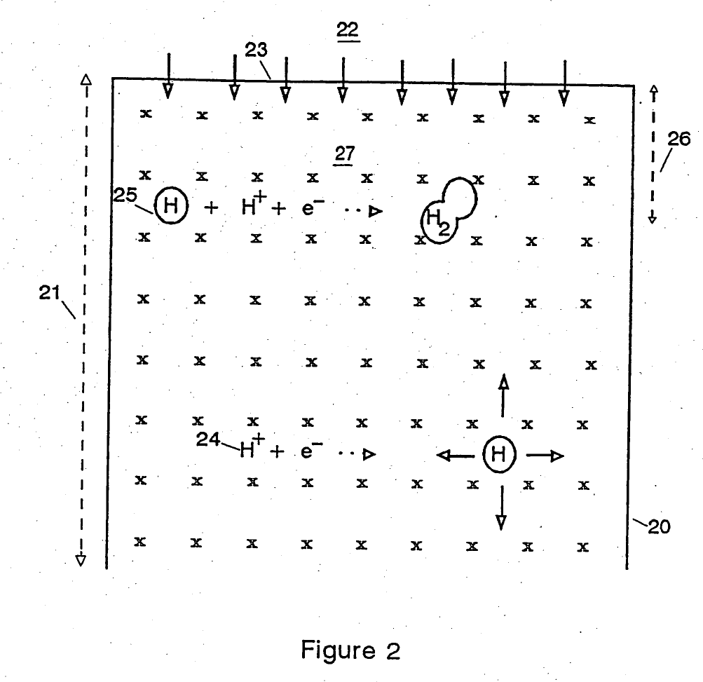

But, as shown in FIG. 2, the first step of the hydrogen mechanism is produced inside electrode 20 in layer 21, 3000 Å to 5000 Å thick (or more), including the surface atoms. The size of the H D T⁺ is about 10⁻⁵ Å. Compared to the size of other ions (1 Å to several Å), and the interatomic distance at the surface of the metal (more than 1 Å), the size of the H D T⁺ is very small. This explains why H D T⁺, if endowed with enough energy, can easily penetrate the electrode. In solution 22, the H D T⁺ particles are in perpetual movement, passing from one water molecule to another easily. As soon as a cathodic potential is applied to the electrode, the H D T⁺ proceed to the surface of the cathode. The first H D T⁺ to come in contact with the cathode react with electrons to become atomic hydrogen, and remain for a little while at the surface. During the second electrochemical step, the atomic hydrogen then reacts with another electron and another H D T⁺ to become molecular hydrogen. The time interval (dt) needed to conclude the two electrochemical steps is short, but much longer than the time interval needed by the other H D T⁺ to penetrate inside the electrode. Because of the electric field generated, the free H D T⁺ react with electrons. However, because the atoms of the surface are already occupied by hydrogen atoms, the free H D T⁺ can not extract electrons from the surface atoms. The free H D T⁺ penetrate through the surface of the metal 23 and, as soon as the free H D T⁺ encounter a free reactional site under the surface, react 24. The thickness of layer 21 depends on the potential applied at the electrode, if the potential is not too cathodic. For very cathodic potentials, the thickness of the layer reaches a limit comprised between 3000 Å and 5000 Å (or more), depending on the nature of the metal and the nature of the isotope (H⁺, D⁺, T⁺). This limit expresses the fact that the penetration of protons is impeded by the presence of numerous electrons in the metal.

The nature of the cathode exerts a very large influence on the second electrochemical step 25. For some metals, the second step occurs inside a very small layer under the surface of the electrode. For these metals, the available space in the elementary cell inside the metal is thus not large enough to contain molecular hydrogen. For a specific category of metals (e.g., platinum), the second step occurs under the surface of the electrode in the same layer 3000 Å to 5000 Å thick or more. This layer is the same as the one where the first step occurs. The layers 26 for other metals are comprised between the results for the two previous categories of metal. In each elementary cell 27 of the layer where molecular hydrogen is produced, the electrochemical mechanism produces energy of 31.3 eV. The energy is used to place the metallic atoms of the layer in a state of vibration, disperse the H D T⁺ inside the layer and help them find the reactional sites available for reaction, disperse atomic hydrogen in the layer and inside the cathode, and, because their size exceeds the size of the free interstitial cells, displace the molecules of hydrogen outside the electrode after the reaction. The molecular hydrogen cannot penetrate the core of the electrode because it is static: this part of the electrode thus acts as a fence which prevents the diffusion of molecular hydrogen inward. Thus, the metallic layer under the surface is an active layer which surrounds a passive metallic core. The metallic layer where molecular hydrogen is produced is dynamic, not static.

I.B. Importance of the Nature of the Cathode

The mechanism which produces hydrogen molecules by electrolysis is both an electrochemical and a physical phenomenon. The successive transformation of H D T⁺ into atoms, then into molecules is only a step in a very complex process where numerous physical parameters intervene. One of the most important factors influencing this reaction appears to be the available volume of free metal lattice. The free volume between the atoms of the metal can be calculated for each atom as follows:
V_{free}=Vₐ−Vᵣₑₐₗ
Vₐ is the apparent volume of the atom
Vₐ=M/(ρ·N)
   where M is the molar mass of the metal, ρ the volumic mass, N the Avogadro number, and Vᵣₑₐₗ is the real volume of the atom calculated as a sphere of atomic radius R. These calculations have showed that in fact the free volume V_{free} is proportional to the apparent volume Vₐ of the atoms, and represents about one fourth to one third of the apparent volume. For this reason, V_{free} and Vₐ are taken to be equivalent when it comes to study the influence of the metal lattice on the reaction. Vₐ however is more interesting because it is easier to calculate even in the case where the metal is an alloy. This is why Vₐ has been chosen to study the influence of the lattice of the cathode.

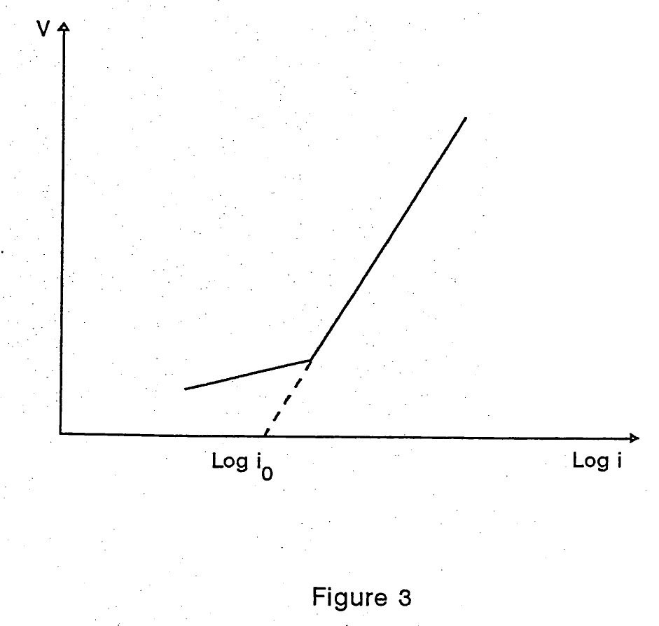

Since Tafel, the relation between current-density I and potential (V) for the hydrogen mechanism is often written as: V=a−b Log I, where i₀, defined as the exchange current-density, equals the current at a potential equal to 0. In the literature, authors who have studied the hydrogen mechanism present their results under the form of curves V=f(log i) (FIG. 3). The current density is the sum of the current densities exchanged in the two electrochemical steps. When the potential is not very cathodic, the current-density is almost entirely caused by the first step (first slope of the curve). When the potential becomes more negative, however, the second step, slower than the first, controls the mechanism (second slope on the curve). The value of Log i₀ is obtained by reading the intersection of this second part of the curve with the axis of Log i.

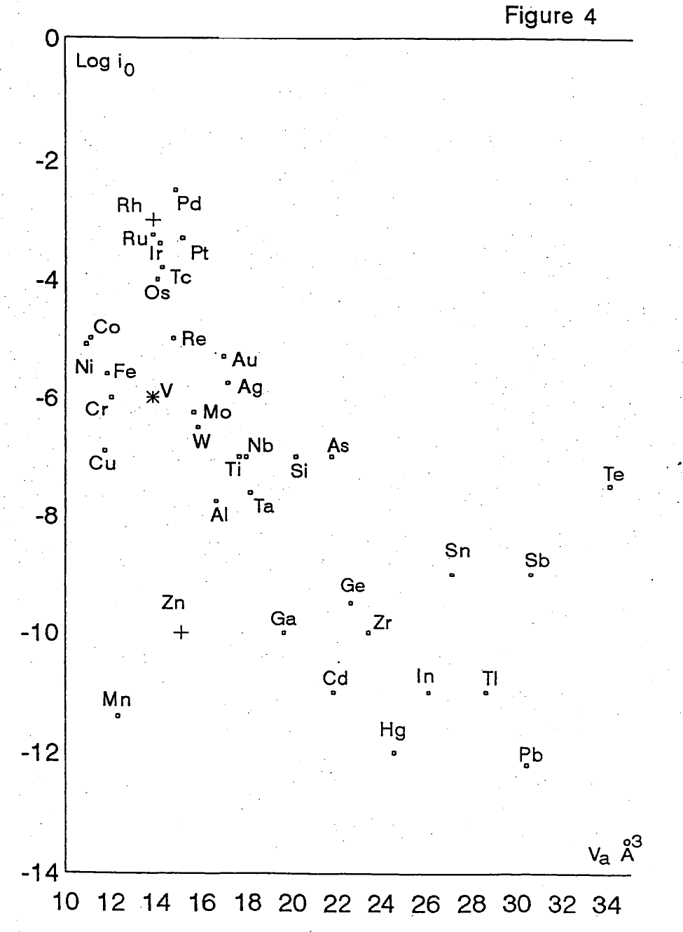

As seen previously, the second electrochemical step occurs in a layer whose thickness is directly related to the nature of the metal. This value of Log i₀ is therefore a good descriptive parameter of the second electrochemical step and is therefore related to the depth of the layer. To show the influence of the lattice of the metal, FIG. 4 presents the evolution of Log i₀ as a function of the apparent atomic volume in acid solution for all the metals studied in the literature: Ag, Al, As, Au, Bi, Co, Cu, Cd, Cr, Fe, Ga, Ge, Hg, In, Ir, Mo, Mn, Nb, Ni, Pb, Pd, Pt, Re, Rh, Ru, Sb, Si, Sm, Ta, Tc, Te, Ti, Tl, V, W, Zn, Zr.

Despite dispersion for some metals, the curve shows a general tendency: when the atomic volumes Vₐ increase, the value of Log i₀ increases and passes a maximum. Its value for great atomic volumes is very low. The maximum of the curve is obtained for ruthenium, iridium, osmium, technetium, palladium and platinum (Vₐ comprised between 13.8 Å³ and 15.2 Å³). The curve, however, presents numerous anomalies for metals such as copper, vanadium, manganese, and zinc. These results, apparently abnormal, are very interesting because they show that other factors intervene and allow us to understand the hydrogen mechanism more completely. Two other parameters are important: the hardness of the metal and its affinity toward hydrogen. For a given atomic volume Vₐ, the hardness and Log i₀ are inversely proportional. The metals that have a strong affinity for hydrogen, (e.g., Zn H₂, VH_{0.71}, NbH_{0.86}, TaH_{0.76}, TiH₂, Zr H₂), all have the lowest Log i₀ of the set for their atomic apparent volume Vₐ. These metals' affinity for hydrogen modifies the structure of the metal and impedes the electrochemical mechanism of hydrogen production. FIG. 4 represents the first resonance phenomenon during the hydrogen mechanism: For the metals of atomic volumes V<13.8 Å³ (Ni, Co, Fe, Cr, Cu, Mn), the free available atomic volume V_{free} (the free volume of the elementary cell) is too small within the metal. The reaction is possible only near the surface of the electrode where the metallic atoms can move more easily. The vibrations of the metal provoked by the energy generated by the first elementary step allows the creation of the elementary cells necessary for the second steps. For the metals whose atomic volume is comprised between 13.8 Å³ and 15.3 Å³ (Rh, Ru, Os, Ir, Tc, Pd, Pt, Re), the free atomic volume V_{free} of the elementary cell is large enough for the formation of a hydrogen molecule. The two atoms H of hydrogen are created and trapped in an elementary cell whose size is only slightly greater than the size of a hydrogen molecule. The distance between the two atoms H is close to 1.2 Å, the distance of Van der Waals below which two atoms of hydrogen are forced to form a molecule of hydrogen. The energy produced through the two steps to form one hydrogen molecule is (31.3 eV). The free volume inside the elementary cell has a size of about 4 Å³ and acts as a resonant cavity for the hydrogen molecules. For the metals of atomic volumes V>15.3 Å³, the free volume of the elementary cell is much larger than the volume of the hydrogen molecule. In these elementary cells, two hydrogen atoms have enough space not to interact. As the atomic volume increases, the second step becomes more difficult to realize since the large elementary cell cannot force the two hydrogen atoms to form a hydrogen molecule. When Vₐ increases, the value of Log i₀ decreases. A careful examination of FIG. 4 allows to determine the factors which control the optimization of the hydrogen mechanism: an atomic apparent volume Vₐ comprised between 13.8 Å³ and 16.4 Å³, the lowest possible hardness, and no affinity of the metal toward hydrogen (except palladium).

Knowing these factors allows for the creation of different alloys (average apparent atomic volume comprised between 13.8 Å³ and 16.4 Å³) for which the mechanism would be greatly enhanced. The metals without any affinity toward hydrogen can be divided into two groups: (Vₐ<15 Å³, for Co, Cu, Cr, Mn, Ni, Fe, Os, Ir, Ru, Rh, etc.) and (Vₐ>15 Å³, for Pt, Au, Ag, Mo, W, Al, etc.). Combinations of metals from these two groups which produce an average apparent atomic volume comprised between 13.8 Å³ and 16.4 Å³ allows for the reproduction of the first resonance phenomenon by creating a free volume inside the cell of about 4 Å³. Some of these alloys are: AuRh, AuRh₂, AgRh₂, AgRu₂, CoAu₂, NiAg₂, FeAu₂, NiAu₂, but many other combinations are possible. Like the metals in the platinum metal group, these alloys facilitate the mechanism of hydrogen production. Those alloys can be used as electrodes inside fuel cells, as catalysts in the mechanisms of hydrogenation, or to eliminate pollution from vehicle-based catalytic devices.

I.C. Creation of plasma inside the cathode

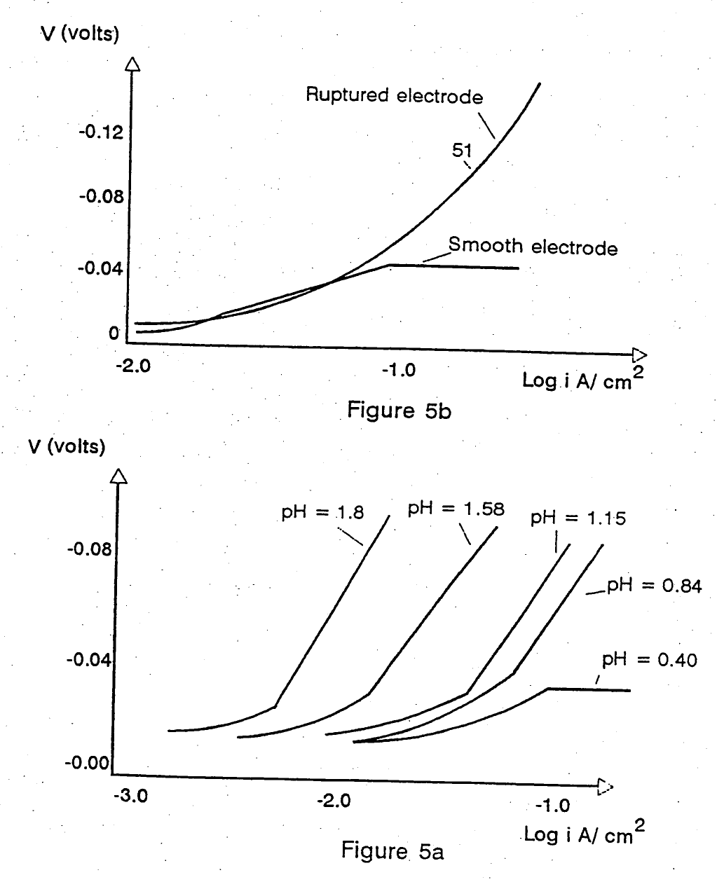

Normally, because of the affinity of palladium toward hydrogen, the Log i₀ of palladium should have a lower value, as those of vanadium, titanium, niobium, tantalum, and the like. The result appears to be incorrect. The behavior of palladium is different because its Log i₀ is close to the resonance's maximum (FIG. 4). The palladium used as a cathode at room temperature absorbs hydrogen atoms to form a beta phase where the ratio of hydrogen to palladium is equal to about 0.66. In acid solution, the behavior of the palladium cathode is very peculiar, as shown by the experiment of Clamroth and Knorr [3], and Schuldiner and Hoare [4]. These experiments are summarized on curves of FIGS. 5a and 5b, which represent the potential V of the palladium in function of Log i. FIG. 5a shows curves representing the pH range 0.4-1.8. These curves are divided into three regions. The first region, at the lowest current densities, shows a linear relationship between current density and potential. The middle region shows a linear relationship between V and Log i with Tafel b slopes progressing from 30 mV to 42 mV at pH=0.84. The third region, at the highest current-densities, also shows a linear relationship between V and Log i, but with a b slope of about 120 mV.

The more acidic solutions are also divided into three regions—the first two regions being essentially the same as the pH 0.84 curve of FIG. 5a. However, the third region, at the highest current densities, flattens out and, in this range, V is virtually independent of current density. Clamroth and Knorr claimed that this limited value of over-voltage remained constant for values as high as 80 Ampere/cm². Parameter b is equal to 0. Since bubbles of molecular hydrogen are formed on the surface of the electrode, current density should depend on potential V. In reality, it does not. As the electrochemical mechanism of hydrogen production progresses, the slope b should have a value of 40 mV. In these experimental conditions, the electrochemical steps are composed of two first electrochemical steps:
H⁺+e⁻→H
+}H₂ Slope b=40 mV
H⁺+e⁻→H

Since it is impossible to produce hydrogen molecules with a slope (b=0), a new phenomenon must be masking the electrochemical mechanism. The palladium electrode behaves as if it was a superconductor. The metal, however, cannot transmit both elementary charges (electrons and protons). The protons, being much heavier than electrons (mₚᵣₒₜₒₙₛ=1836 m_{electrons}), are considerably more difficult to displace and are therefore much slower. The electrons can move inside the metal with a speed measured in m.s⁻¹, while protons can only achieve speeds measured in mm.s⁻¹. If protons could move as easily as electrons inside the metal, the protons could find a free reactional site in which to react with the electrons, and slope b would therefore be equal to 40 mV. But since the slope is nil, protons and electrons remain inside the electrode, without reacting, under plasma form. The total current-density consists of two parts: the first part consists of the two first electrochemical steps, with a slope b=40 mV, and the second part H⁺+e⁻→Plasma, where slope b=0 mV.

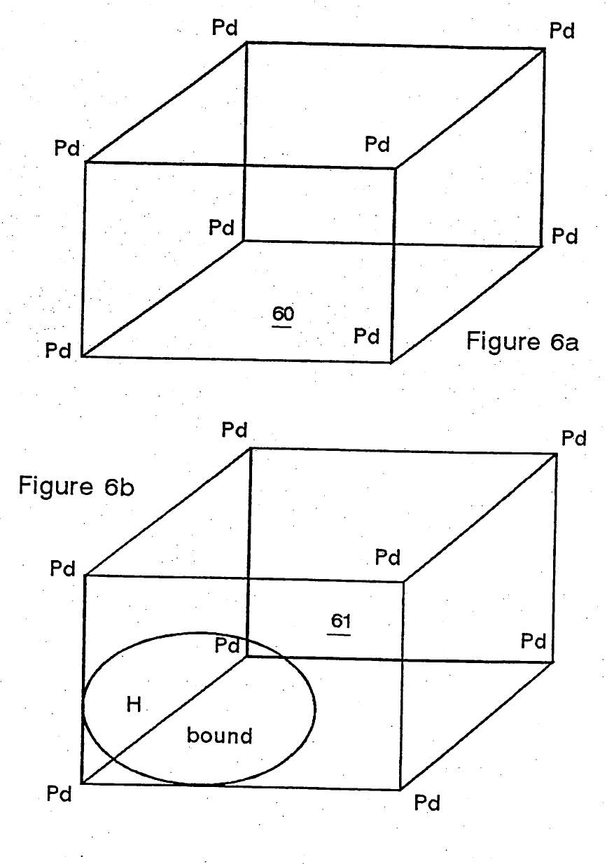

When the second part of the reaction becomes more dominant than the first, slope b is equal to 0. This new phenomenon masks the effect of the electrochemical mechanism (first part), for large current densities and pH<1, more particularly pH<0.84. The palladium stores the plasma, whose concentration increases with time. The structure of palladium explains the formation of plasma. The palladium cathode is made of PdH_{0.66}. Two thirds of the palladium atoms are bound with one hydrogen atom. The remaining third are completely free to react. Therefore, there are two categories of elementary cells (presented in FIG. 6). To simplify the drawing, the cell is represented as if the palladium were cubic in shape.

The first category 60 is that of the elementary energy cells. There is no hydrogen atom bound to a metallic atom inside this kind of elementary cell. The volume of the cell is completely available for the electrochemical mechanism:
2H⁺+2e⁻→H₂+31.3 eV

Energy of 31.3 eV is produced with each hydrogen molecule. The energy only appears in this kind of elementary cell, hence the name elementary energy cell. The energy created inside the electrode is transmitted to the protons that are dispersed in all directions inside the electrode, the hydrogen molecules in the form of kinetic energy which helps them depart the electrode and the palladium atoms, which receive the energy by impulse.

The second category 61 is that of the elementary plasma cell. These cells have one hydrogen atom bound inside, and represent two thirds of all existing elementary cells. In the elementary plasma cells, the volume available is approximately equal to the volume of a hydrogen atom. It is thus impossible to realize the second electrochemical step inside the elementary plasma cells because there are too many protons inside the elementary cell and because the palladium atoms are always in a state of vibration caused by the elementary energy cells. The cells are always experiencing a rapid movement of compression-expansion. The vibrations thus forbid the combination of the H D T⁺ and of the electrons inside the cell. The particles remain in their plasma form. The elementary plasma cell has a free available volume of about 2 Å³ that acts as a resonant cavity for the hydrogen atom. This is the second resonance phenomenon.

However, with extensive cathodic polarization and low pH solutions, a plasma overcharge can result, creating deep pits, cracks and blisters on the electrode. Hoare and Schuldiner [4] show in FIG. 5b that the electrodes 51 that underwent such a treatment lose their property to produce b=0. These cracked and pitted electrodes cannot be used to create plasma inside the layer. The true cause of these microcracks, deep pits and blisters is that the electrochemical reaction is produced inside the electrode. The formation of the hydride PdH_{0.66} provokes a distention of the metallic lattice of the cathode. Then the impulses that occur every time a hydrogen molecule is created produce vibrations inside the metal. If the vibrations are disorderly and anarchic, they cancel each other. But with time, the impulses become more or less synchronized. The effect of the impulses and of the vibrations is cumulative. The compressions and extensions of the elementary cells increases to large degrees, and the metal fatigue produced by these large amplitude variations creates cracks in the metal. When there are many cracks on the surface, the vibrations can only propagate in some small parts of this surface. The cumulative effect of the vibrations and the plasma inside disappear.

Understanding this second resonance phenomenon allows other elements having the same properties (size and affinity toward hydrogen)—such as vanadium (Vₐ=14.6 Å³), zinc (Vₐ=15.3 Å³)—to be found, or alloys that duplicate this property to be created. The alloys preferably possess a resonant cavity or free available volume inside the elementary cell comprised between 1.75 Å³ and 2.5 Å³ or an average apparent atomic volume between 13.8 Å³ and 16.4 Å³. The cavity has the size and shape to accommodate only one hydrogen atom. But because of the vibrations of the metal and the excess of H D T⁺ in the cavity, the H D T⁺ and electrons inside the free volume remain in the form of plasma. It is possible to build this particular cavity inside alloys by several means: The first means is to duplicate the structure of palladium. The alloys present the first resonance phenomenon property and produce the hydrogen molecule already described (available free volume in the elementary cell comprised between 3.75 Å³ and 4.5 Å³). At least one of the metals composing the alloy presents an affinity toward hydrogen so that the alloy presents an affinity toward the hydrogen as well. The alloys are a combination of:
elementary cells free of hydrogen and available for the hydrogen electrochemical mechanism. These elementary cells, which have the size required by the resonance (14.9 Å³) and a free internal volume of about 4 Å³, allow the production of hydrogen molecules and of an energy of 31.3 eV by elementary reaction. The produced energy causes the vibrations of the plasma and of the metallic atoms. These elementary cells are the “energy cells.”

elementary cells with one hydrogen atom bound to one metallic atom. The remnant of the volume of the elementary cell is about 2 Å³. The shape of this free volume is adequate to contain one hydrogen atom. Through the mechanical vibrations of the metal, the remainder of the cell acts as a resonator for the proton, and prevents the proton from reacting with an electron. These elementary cells are “plasma cells” since they allow a high density of plasma to be obtained in a small volume. The ratio between the two kinds of cells will depend on the applications and the experiments performed. The metals necessary to create the alloys can be divided in categories according to their affinity to hydrogen and their apparent atomic volume Vₐ:

| Vₐ Å³ | Vₐ < 14 Å³ | 14 Å³ < Vₐ < 15.3 Å³ | Vₐ > 15.3 Å³ |
|---|---|---|---|
| Metal I | Ni, Cu, Cr, | Os, Ru, Rh, Ir, Tc | Au, Ag, Cd |
| No affinity | Fe, Co, Mn, | Re, Pt, Mo, W, etc . . . | Hg, Al, etc . . . |
| | etc . . . | | |
| Metal II | Be, etc. | Zn, Pd, V, etc . . . | Nb, Ta, Ti, Zr |
| Affinity | | | Sn, Sc, Y, La, |
| | | | La series, Hf, |
| | | | etc . . . |

It is possible to replicate the structure of palladium by combining two, three or more metals from the different categories. The different alloys allow variations in the percentage of energy and plasma cells, the hardness, the size and shape of the resonant cavity required by the second resonance phenomenon. Some alloy combinations are given here: Zn Ni Al₂, Zn Co Al₂, Zn Ni Al Nb, Zn Ni Al Ta, Zn Ni Pt Ag, Ni₃Sn, Co₃ Sn, Nb Ni, Nb Co, Nb Cr, V Ni Nb, V₂ Ni Nb, V Co Nb, V₂ Co Nb, V₂Cr Nb, V Cr Nb, Mn Nb, Mn V Nb, Mn V₂ Nb, V₂Cr Ta, V Cr Ta, V₂ Cr Ti, V Cr Ti, V₂ Fe Nb, V Fe Nb, La Ni₅, Mm Ni₅ where Mm is the mish metal (25% La, 53% Ce, 5% Pr, 17% Nd), Mm_{0.9} Ni_{3.7}, Mm_{0.5}Al_{0.4}, etc. . . . FeNb, TaCo, TaCr, TaNi, TaFe, alloys of W and V, such as WV₂, WV₃, etc. It is possible to create many more alloys that would conform to the second resonance phenomenon criteria. Like palladium and the metals in the platinum metal group, these alloys facilitate the mechanism of hydrogen production. These alloys can be used as electrodes inside fuel cells, as catalysts in the mechanism of hydrogenation or to eliminate pollution from vehicle-based (e.g., car) catalytic devices.

The second manner to duplicate the properties of palladium is to use a metal or alloy with an average apparent atomic volume comprised between 20 and 22.5 Å³. In function of the crystallographic structure of the metal or alloy, the free available volume varies between 5 and 6 Å³ or 5.62 and 6.75 Å³. If it is possible to bond two hydrogen atoms inside each elementary cell, the remnant of the free volume will be close to 2 Å³, and will have just the size and shape necessary to contain one hydrogen atom. This volume acts as a new resonant cavity during the second resonance phenomenon and allows the formation of plasma. These alloys are composed of large atoms. Some of these alloys and metals are, for example, Zr, As, Sn Al, Sb Al, Zr Al, and Cd As.

A third method to create a resonant cavity of 2 Å³ is to bond three hydrogen atoms in an available free volume of about four hydrogen atoms (8 Å³). The average apparent atomic volume Vₐ of such an alloy or metal should be around 30 Å³. Some of these metals or alloys are Sb, Pb Sb, Te Pb Sn.

A fourth method to duplicate the properties of palladium is to use very small atoms without hydrogen bonded inside the elementary cell. The smaller atoms with electrical conductivity are: beryllium ((Vₐ=8.3 Å³), carbon (Vₐ=8.8 Å³) (graphite, glassy carbon, vitrous carbon, composite carbon, ect.), nickel (Vₐ=11 Å³) and cobalt (Vₐ=11.1 Å³). Carbon and the alloys (e.g., Ni C and Co C) can form a free volume for near resonant cavity, about 2 Å³.

But many of these alloys or metals dissolve in acidic solution even at cathodic potential. Their external surfaces must be protected, for example, by a layer of palladium. With this protective layer, these alloys and metals can be used as cathodes to produce plasma solid.

The metals and alloys described in the previous part are not the only ones that can allow the creation of plasma of H D T⁺. As seen previously in parts I.A. and I.B., the electrochemical mechanism of hydrogen production occurs in a layer under the surface for all the metals. The thickness of this layer depends very much on the nature of the metal. For metals other than those in the group of palladium, platinum, etc., the electrochemical mechanism is less efficient and requires more electrical energy to occur. For a same current density, the potential of the cathode is made more negative. The free space of the cells inside the lattice is larger than that for the palladium. These materials have properties less favorable to the creation of plasma. But by using more energetic experimental conditions (e.g., larger current-density, more negative potential, ionic solution much more acid, very energetic vibrations of the cathode (see next paragraph)), it is still possible to create plasma solids of H D T⁺ inside these metals. Every electric conductors that can serve as a cathode can be used to produce plasma solid. The cathode can be created by using the following elements:
lithium, beryllium, boron, carbon, sodium, magnesium, aluminum, potassium, calcium, scandium, titanium, vanadium, chromium, manganese, iron, cobalt, nickel, copper, zinc, gallium, germanium, arsenic, rubidium, strontium, yttrium, zirconium, niobium, molybdenum, technetium, ruthenium, rhodium, palladium, silver, cadmium, indium, tin, antimony, tellurium, cesium, barium, lanthanum, cesium, praseodymium, neodymium, promethium, samarium, europium, gadolinium, terbium, dysprosium, holmium, erbium, thulium, ytterbium, lutetium, hafnium, tantalum, tungsten, rhenium, osmium, iridium, platinum, gold, mercury, thallium, lead, bismuth, polonium, francium, radium, actinium, thorium, protactinium, uranium, neptunium, plutonium, americium, curium, berkelium, californium, einsteinium, fermium, mendelevium;

or with alloys with the following properties:
any combination of the previous elements;
any combination of the previous elements with the non-metallic elements, nitrogen, oxygen, fluorine, silicon, phosphorus, sulfur, chlorine, selenium, bromine, iodine;

or with the electrical conductors as follows:
any kind of carbon, e.g., graphite, vitreous carbon, composite carbon, glassy carbon, fullerene, etc.;
any borides, such as Ni₂B, NiB₂, MnB, MnB₂, Cu₃B₂, etc.;
any carbides, such as TiC, ZrC, HfC, V₂C, VC, Nb₂C, NbC, TaC, Ta₂C, Mo₂C, MoC, SiC, B₄ C, W₂ C, WC, ThC, U₂ C₃, VC, Ce₂C₃, Np₂C₃, PuC₃, CeC, NpC, PuC, and the carbides of Cr, Mn, Fe, Co, and Ni;
any electrical conductors of organic composition.

But many of these elements, alloys or materials (duplicating or not the properties of palladium) dissolve in aqueous acid solutions even at cathodic potential. In an acid bath, their external surfaces must be protected, for example, by a layer of materials which are unimpeachable in these conditions, such as, for example, C, Nb, Rh, Pd, Ta, W, Os, Ir, Pt, Au, Hg, Pb, and/or carbides. With the protective layer, these elements, alloys or materials can be used as cathodes to produce plasma solid.

I.D. Creating Plasma Using the Entire Cathode

During the electrolysis, the hydrogen atoms created in the layer under the surface can migrate in all directions. Progressively, it is possible to saturate the inside of the palladium electrode from PdH_{0.66} to PdH. Once the saturation is obtained (one hydrogen atom per palladium atom), the entire core of the electrode is converted into plasma cells. The free volume available per palladium atom is equal to the volume of one hydrogen atom. The electrode thus becomes a layer of energy and plasma cells surrounding a core composed uniquely of plasma cells. The “plasma cells” of the cathode are of two kinds. The “plasma cells” of the layer are in a state of vibration and can store plasma. Those “plasma cells” are active. The core of the electrode is static. The “plasma cells” in this region cannot store plasma. These “plasma cells” are passive. As seen previously in FIG. 4, for a given atomic volume Vₐ, the Log i₀ parameter diminishes when the hardness of the metal increases. This means that the movement of the metallic atoms is very important for the electrochemical mechanism. The larger the movement of the atoms, the thicker the active layer will be. Every time two protons meet two electrons in an energy cell, energy in an amount of 31.3 eV is produced. The creation of this elementary energy, as well as the vibrations it produces, is chaotic. By using an acid solution, it is possible to organize the mechanism to a certain extent. In this solution, two first steps of the electrochemical mechanism occur at the same time to produce a hydrogen molecule and an elementary energy of 31.3 eV. However, the energy production inside the layer is still chaotic.

To improve the mechanism, the energy production and the vibrations of the metallic atoms may be synchronized. If the vibrations are erratic or random, the cumulative effects of the vibrations are small. However, if the elementary impulses of energy are coordinated, the progressive accumulation of energy increases the amplitude of the vibrations and the degree of compression inside the electrode. Each metallic electrode has a set of resonance frequencies that depend on the shape of the electrode, the nature of the metal, and the freedom (or lack thereof) of its extremities. If the electrode is solicited through one of these frequencies, stationary waves are established throughout the electrode, with nodes and anti-nodes of vibration. Thus, by using a constant current density to which are added periodical impulses (alternative, triangular, square, rectified alternative, double rectified alternative, etc.), it becomes possible to force the periodic entry of similar protonic waves. These waves of H D T⁺ push periodically the H D T⁺ which are already inside the electrode and compress them against each other. The periodic repetition of these impulses coordinates the vibrations of the metal.

It is possible to vary the characteristics of the pulse in function of the experiments or applications performed (e.g., the shape, the amplitude, the frequency). The frequency of the impulse is adjusted for each cathode to one of the mechanical resonance frequencies of the electrode. It is also possible to solicit the electrode through one of its resonance frequencies by mechanical means (mechanical waves). These waves can be communicated to the electrode through the liquid solution, through the wire which conducts the current, or by using a magnetic transducer, etc. The frequency of the mechanical vibration can be audible or ultrasound, but corresponds to the resonance frequency of the electrode. The use of the electrode's resonance has three very important consequences:

The synchronization of energy formation inside the layer allows the amplitude of the vibrations of the metallic atoms to be increased. The amplitude of the vibrations can be adjusted as a function of the application desired. The use of the resonance phenomenon creates areas where the vibrations are at their maximum. The areas where the stationary waves have a large amplitude occupy a large part of the total volume of the electrode. The protons submitted to the metallic vibrations are dispersed throughout the electrode, including the core composed of plasma cells. It is therefore possible to obtain plasma-solid both in the active layer and inside the electrode. The vibrations also facilitate the entrance of the H D T⁺ inside the cathode and divert a larger part of the H D T⁺ toward the core of the cathode where they remain in the form of plasma. The artificial vibrations applied to the cathode lower the threshold of the current density necessary to create plasma inside the cathode. This threshold can be as low as 50 mA/cm² or lower, depending on the nature of the cathode material.

When using any electrical conductors, elements, or alloys as a cathode to obtain plasma solid, the same method of vibration inducement is used. Thanks to the conditions of resonance, very energetic vibrations are generated. The properties needed to create plasma are much less favorable than with palladium or an alloy like palladium. But by using large energetic vibrations, these impediments to the creation of plasma solid can be partly compensated.

I.E. Structure of the Plasma Inside the Solid

The distribution of the plasma inside the solid is not homogeneous. Whatever the nature of the cathode may be, the plasma is created inside the free elementary interstitial volumes. These free volumes are surrounded by several atoms, each containing many protons.

In the case of palladium and the alloys which duplicate the properties of palladium, the free volume is about 4 Å³. But in the “elementary plasma cell”, half of this free volume is occupied by one hydrogen atom bonded to one of the metallic atoms. The rest of the free volume inside an elementary plasma cell is not subjected to the electric fields generated by the metallic atoms. The plasma produced inside the plasma cells is contained in the free volume (2 Å³). When one H D T⁺ enters this cavity, it cannot associate with an electron because of the vibrations. As soon as another H D T⁺ enters inside the cavity, the two H D T⁺ repulse each other and keep the largest distance possible between themselves. The same goes for the electrons. When a H D T⁺ attempts to leave the free volume, it is subjected to a repulsive force generated by the metallic atoms of the cell and is prevented from departing. The free volume inside the cell has the approximate shape of a sphere. However, inside the free volume, the plasma is not homogeneous. As other H D T⁺ enter, the entering particles occupy a kind of spherical crown at the periphery of the sphere.

In the case of other materials used to produce plasma, the free elementary interstitial volume is superior to 2 Å³. With these materials, producing plasma is less easy. As seen previously by using more energetic experimental conditions it is possible to create plasma solid. As in the case of palladium, the H D T⁺ particles in the form of plasma occupy a spherical crown inside the free elementary interstitial volume.

Submitted to the vibrations of the metallic atoms, the plasma is in constant movement inside the spherical crown. Inside the sphere, the H D T⁺ move in one direction. The electrons move in the other direction to avoid the attraction between the two particles. The movements of the two opposite electrical charges in opposite directions are equivalent to the movements of two parallel electrical currents of similar electrical charge in the same direction. A “Pinch effect” thus appears between these moving charges which allows the plasma to be stabilized inside the spherical crown. The size of the spherical crown is not constant because the plasma is constantly submitted to the vibrations generated by the metallic atoms. The structure of the plasma in this particular situation is similar to that found in a tokamak. The “elementary cells” behave as small tokamak or “nanotokamaks.” By using stationary waves inside the cathode, the vibrations can be maintained in the same directions and therefore the solicitations exercised against the “nanotokamaks” can be synchronized. If the shape of the cell is not cubic, the shape of the plasma crown can be ellipsoidal. Likewise, if the vibrations are not applied symmetrically, the shape of the plasma crown can be asymmetrical. However, in these cases, as in the case of the spherical plasma crown, the electric field is nil inside and outside the plasma crown because of the electrical neutrality of the plasma and Gauss' law. Likewise, because the movement of the opposite electrical charges is equivalent to two electrical currents moving in the same direction, the plasma crown behaves as a spherical toroid. Because of Ampere's law, the magnetic field B generated by the moving charges is equal to 0 outside the plasma crown.

I.F. Experimental Conditions to Create, Retain and Release the Plasma Solid

The creation of plasma inside a solid material is contingent upon numerous experimental conditions, including: the nature of the cathode, the current density, the difference in potential between the cathode and anode, vibrations of the cathode, and the nature of the media in which the solid cathode is placed. The H D T⁺ which form the plasma solid can enter under many different forms, such as atoms, molecules, or H D T⁺, from many different media such as ionic solutions with H D T⁺, plasma gas of H D T⁺, or atmospheres of hydrogen atoms or molecules. If the particles are charged, moving the particles inside the solid will entail using electrical means. If the particles are electrically neutral atoms or molecules, moving the particles inside the solid will entail manipulating the pressure of the gas.

II. Creation of Plasma Solid

II.A. Creation of Plasma Solid from an Ionic Solution

With an ionic solution as the source of H D T⁺, the method is a classical electrolysis. However, the different parts of the electrolysis cell respect certain conditions.

(1) Ionic Solutions

The storage of plasma inside the cathode requires that the ionic solutions contain the ions H D T⁺ in sufficient quantities. The ion quantity is raised to sufficient levels by adjusting the pH of the solution to be inferior to 1. With an electric field of one volt/cm, the ionic mobility of H⁺ is about thirty micron/s. To maintain a current density of 0.1 A/cm², the ionic solution preferably gives 6×10¹⁷ HDT⁺/cm².s to the cathode. With a pH inferior to 1, the number of HDT⁺/cm³ available in the solution is superior to the number of H D T⁺ necessary for the electrochemical mechanism of H₂. Part of the HDT⁺ entering the cathode is used to produce H₂. The other part is stored inside the cathode in the form of plasma. The more acidic the solution, the greater the proportion of HDT⁺ available to form plasma will be. When the pH is greater than 1, the number of HDT⁺/cm³ in the solution is insufficient. All the HDT⁺ coming into the cathode are used to produce molecular hydrogen. The proportion available to form plasma is negligible. To maintain the same current density, it is necessary to increase the electric field so as to augment the ionic mobility of the HDT⁺. The more basic the solution, the more difficult, if not impossible, it becomes to form plasma. The more cathodic the potential becomes, the deeper inside the cathode the electrochemical mechanism will occur. The storage of atomic hydrogen becomes correspondingly easier. The acid solutions can be prepared with any acid AxHy, AxDy, AxTy (where A is an anion) which allows the creation of pH<1 in H₂O, D₂O or T₂O. Numerous acids can be used. For example, acids such as H₂SO₄, D₂SO₄, T₂SO₄, HCl, DCl, TCl are appropriate.

The solution is maintained in constant motion—such as through magnetic agitation or with a pump—in order to maintain similar properties at the surface of the cathode. To avoid contamination of the cathode, the solutions are very pure. If any impurities (such as organic molecules, ions, metallic ions, or the like) pollute the solution, the metal will lose its surface characteristics. The anions of the acid, or the dissolved part of the cell container or of the insulation of the electrical part (e.g., polyethylene, polypropylene, silicone, polyvinyl . . . ) can react on the electrodes and produce new chemical products. To avoid these secondary reactions, the ionic solution is circulated constantly outside the electrolysis cell. During this circulation, the solution is cleaned by filtering, chemical processing, exposuring to ultra violet. Likewise to avoid the contamination of the cathode with elements produced by the anodic dissolution, the anode preferably is made of a noble or unimpeachable metal (platinum, for example).

If oxygen or chlorine is produced inside the electrolysis cell, it is better to prevent the interaction of these gases with the cathode or with the hydrogen inside the electrolysis cell.

(2) Electrodes

The metal of the cathode is preferably made of either palladium, palladium-like alloy previously described, or of any element, alloys or materials already cited in part I. However, among all the materials cited above, only carbon, niobium, ruthenium, rhodium, palladium, tantalum, tungsten, osmium, iridium, platinum, gold, mercury, and lead can be used in acid solution as a cathode without any corrosion or transformation of the surface of the electrode. The cathode using other elements will either sustain corrosion, dissolution, oxidation, or corrosion by formation of gaseous hydride of the surface or layers of hydride, sulfide, chloride will appear on their surface. For all these materials, the surfaces of the cathodes are polluted and loose the characteristics necessary to produce plasma. All these materials can still be used as cathodes to produce and store plasma, as long as their surfaces are protected from the acidic environment by a layer of unimpeachable material, such as: C, Nb, Rh, Pd, Ta, W, Os, Ir, Pt, Au, Hg, Pb, carbide, etc. This layer protects the inside of the cathode from the acid solution. The protective layer can be deposited on the surface of the cathode by vaporization under vacuum, cathodic plating, ionic implant, powder under pressure, immersion in the melting element, formation of carbide with a laser, or any other suitable technique. Another possibility is to cast the metal to be protected inside an empty container with thin sides made of unimpeachable material. The cathode can also be made from very porous materials. These cathodes allow the solution to pass through the solid. The surface available to create the plasma solid in the layer is thus increased accordingly.

The anode is to be made of a noble metal or unimpeachable metal (platinum, iridium, rhodium, stainless steel, etc.). The area of the anode in contact with the ionic solution is adjustable to vary, for example, from very small to very large by comparison to the area of the cathode. This adjustment can be obtained by immersing more or less of the anode inside the ionic solution. This adjustment can also be achieved by moving an insulator along the surface of the anode to vary the area of the anode in contact with the solution accordingly. This adjustment of the area allows the electrochemical process to be controlled at the anode (production of O₂, Cl₂ . . . ). When the area of the anode in the solution diminishes, it becomes necessary to augment the difference of potential between the electrodes so as to keep the current density arriving at the cathode at the same level. The increase of potential also attracts larger quantities of products (e.g., ions, atoms, molecules) necessary for the anodic reaction. It speeds up the electrochemical process on the anode (current density increase). At the cathode, the current density remains the same. But the greater difference in potential provokes a larger accumulation of H D T⁺ around the cathode. This augmentation of the concentration of H D T⁺ near the cathode facilitates the penetration and the storage of plasma inside the cathode.

Using a fuel cell anode as anode is yet another possibility. The electrolysis occurs inside a closed cell containing the gases H₂ D₂ or T₂. They react on the fuel cell anode:
(H₂, D₂, T₂)→2(H⁺, D⁺, T⁺)+2e⁻

(3) Direct Current and Pulsed Current.

As seen previously, each elementary reaction that produces one molecule of H₂ also produces 31.3 eV. This energy appears inside a layer under the surface of the cathode. It provokes the vibrations of the metallic atoms of the layer. These vibrations if large enough cause a part of the H D T⁺ entering the cathode to become plasma and remain so as long as the vibrations are maintained. The direct current density applied to the cathode exceeds the threshold of 50 mA/cm². This threshold can be lowered depending on the nature of the material used to create the cathode, and the intensity of the artificial vibrations applied to the cathode.

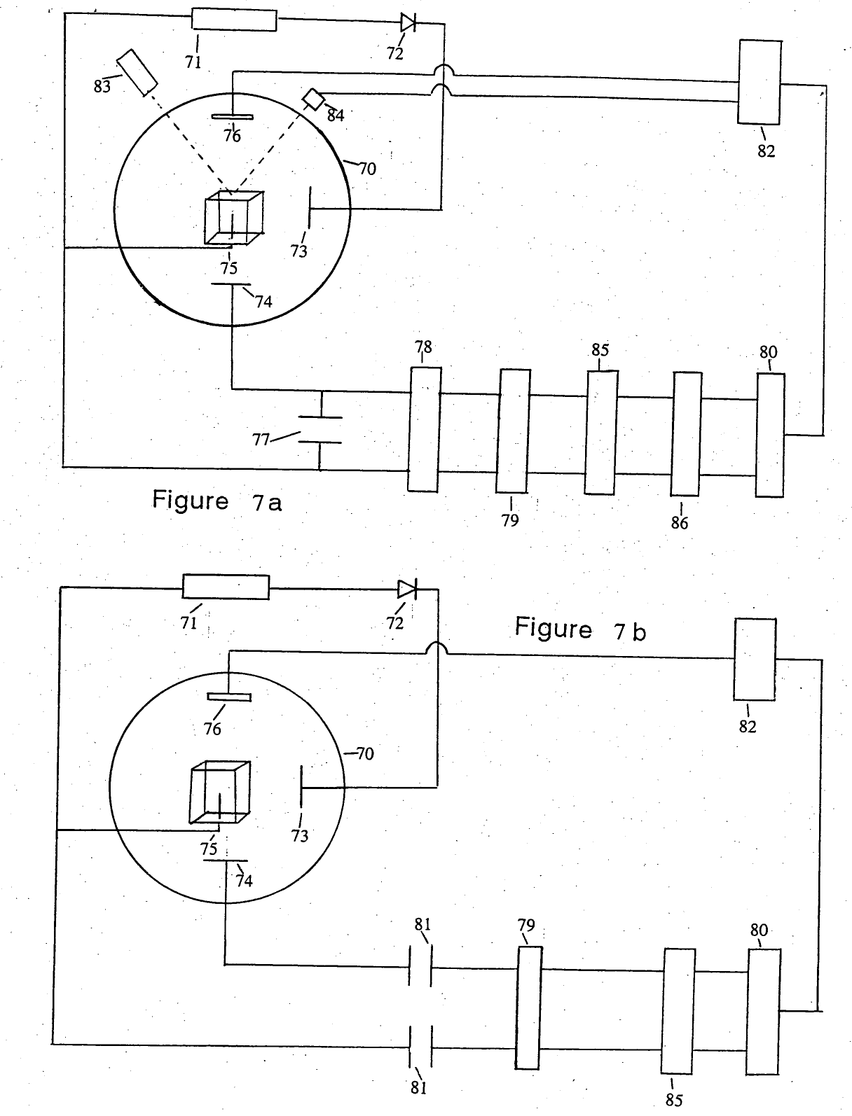

The pulsed current, which is added to the direct current, can have any shape: alternative, square, triangular, pulse, rectified alternative, double rectified alternative, etc. The addition of the two currents can be accomplished according to the method described in FIG. 7a or 7b. A power source 71 provides the direct current to the electrolysis cell 70 between anode 73 and cathode 75. The pulsed current (rectified alternative in FIG. 7a) is added from an amplifier 80. The transformer 79 serves as an impedance adapter and an electric insulation for the amplifier. The alternative signal passes inside a rectifier or a bridge rectifier 78 with a filter 77. The pulsed current (alternative signal FIG. 7b) comes from the amplifier 80. The transformer 79 is used as an impedance adapter. In both FIGS. 7a and 7b, the pulsed current is introduced to the electrolysis cell between cathode 75 and anode 74. However, it is also possible to use the anode 73 for the direct and pulsed currents. Using different anodes for the two currents allows the user to choose the optimal area of anode for each current. The two circuits, direct and pulsed, are isolated from each other either by the rectifier 72 and by the bridge rectifier 78 (FIG. 7a) or by two capacitors of high capacitance 81 (FIG. 7b). This insulation forces the two currents to pass into the electrolysis cell 70, which has an impedance of some tenth of ohm.

(4) Vibrations Created by Pulsed Currents

The pulsed current added to the direct current provokes waves of H D T⁺ (at the same frequency of the pulsed current) to enter inside the layer under the surface of the cathode.

Correspondingly waves of released energy and vibrations appear as these particles H D T⁺ react with electrons to form H₂. So long as the frequency of these waves are chaotic, the vibrations inside the core of the cathode are negligible. To obtain large energetic vibrations, the frequency of the pulsed current is at one of the resonance frequencies of the cathode. The lower frequency or fundamental produces the larger vibrations. Depending on the size of the cathode, the amplitude of the vibrations can reach a tenth of mm, which is equivalent to the length of several 10⁵ stacked atoms. The value of the fundamental frequency depends on the nature of the material (e.g., young modulus, density), and the size, shape and mode of sustentation of the cathode. If the shape of the cathode is irregular, the resonance is not the same inside the cathode in all directions, limiting the synchronization and the amplitude of the vibrations.

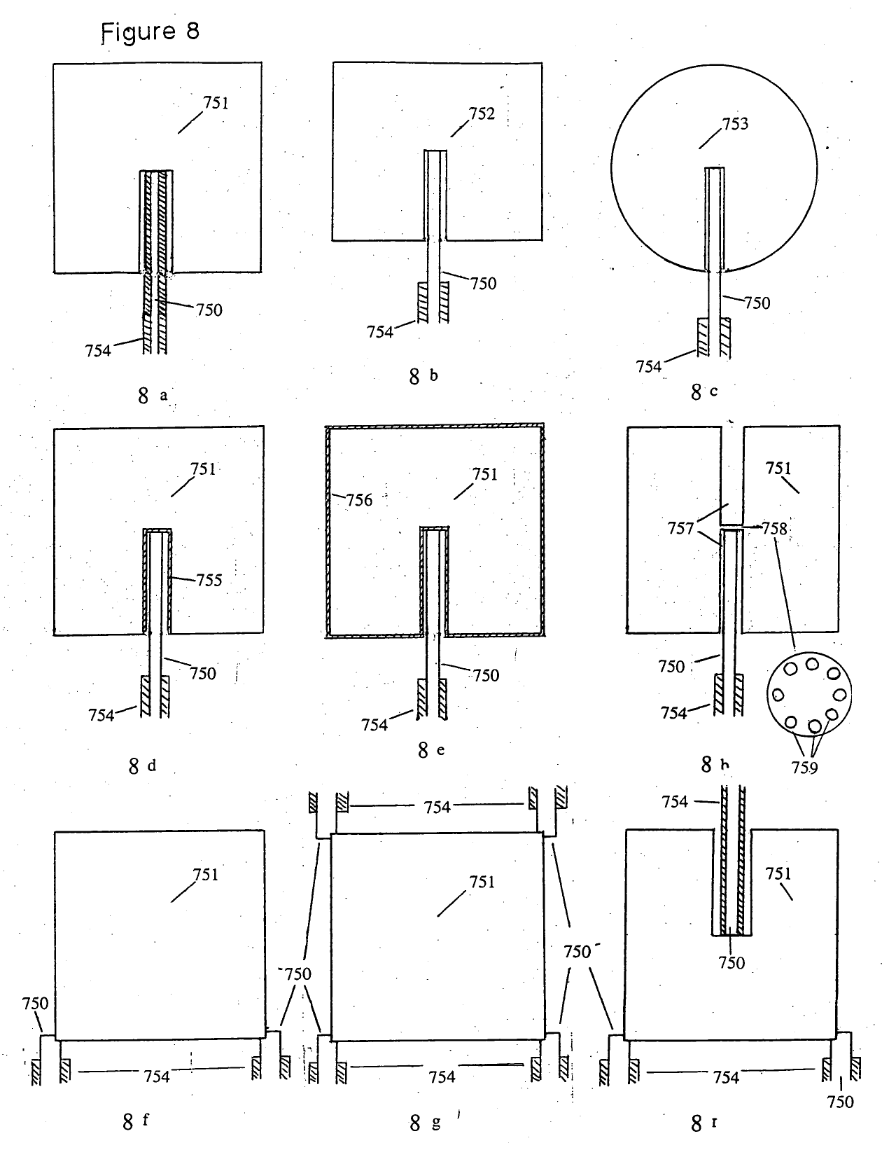

For better results, the cathode 75 is symmetrical (FIG. 8). Thus, the shape of the cathode can be a block, e.g., cubic (751), or spherical (753), among others. In the case of a cylindrical shape (752), the radial and longitudinal vibrations are adjusted to create the resonance. The quotient of the diameter of the cylinder by its length is set equal to 1.178 or 3.393. The first value produces the best results. The shape of the cathode can also be a square parallelepiped. The length of the parallelepiped is set to be a multiple integer of the size of the side of the square. Other symmetrical shapes are also possible.

The first type of sustentation of the cathode allows the cathode to move freely (FIG. 8). The cube 751, the cylinder 752 and the sphere 753 are upheld through their center of gravity by a support, such as a long metallic rod 750 penetrating through the center of one of the basis (cube and cylinder) or extending along a radius for the sphere (FIGS. 8a, 8b and 8c). The center of gravity is a node of vibration at resonance and this sustentation allows these cathodes to move freely without impeding the vibrations. For a better sustentation, the rod 750 ends with a sharp point so as to limit the contact of the rod with the center of gravity of the cathode. However since the rod 750 also conducts the direct and modulated currents to the cathode, the surface of the rod at its pointing end cannot be too small. The rod is made of unimpeachable material: carbon, palladium, platinum, tungsten, gold, niobium, tantalum, iridium, rhodium, stainless steel. Outside the cathode, the rod 750 is covered with an electric insulation 754 to avoid any electric contact with the ionic solution (silicone, polyvinyl, polyethylene, polypropylene). This insulation can be extended to protect the entire lateral surface of the rod (FIG. 8a). Only the end of the rod is free for the conduction of currents to the cathode. Thus a difference of potential is established between the center of the cathode and its external surface. This difference of potential helps the penetration of the H D T⁺ particles through the cathode surface toward the center of the cathode.

The ionic solution also penetrates inside the sustentation hole of the cathode. Because of the electrochemical mechanism, over pressures of hydrogen appear in the hole. Among the materials used for the cathode, some are very sensitive to this over pressure and suffer degradation inside the hole. Sliding a tube 755 a tenth of mm thick along the rod protects the surface inside the hole (FIG. 8d). The material of this tube may be made of unimpeachable material such as the materials previously cited for the rod. Material 755 (FIG. 8d) can also be an insulating material such as polyvinyl, silicone, polyethylene, polypropylene, or the like. The insulating material prevents contact between the cathode and the solution inside the cylindrical hole. There is no electrochemical mechanism occurring on the lateral surface of the hole. This insulating material also constitutes a barrier that prevents the escape of plasma through the lateral surface of the hole.

Active means can also be used to prevent the escape of the plasma through the lateral surface of the holes 757 (FIG. 8h) located inside the cathode. In FIG. 8h, two holes 757 are drilled along an axis of symmetry at the top and at the bottom of the cathode directly opposite each other. The two cavities (holes 757) are separated by a thin disk of cathode material (part 758) which surrounds the center of gravity of the cathode. Rod 750 (isolated, or not, using electric insulation 754) penetrates the bottom hole until the rod 750 reaches part 758 so as to sustain the cathode through its center of gravity. Small holes 759 are drilled along the periphery of part 758 (FIG. 8h). These holes 759 connect bottom hole 757 to top hole 757. The holes 759 allow both the escape of hydrogen gas and the presence of ionic solution inside both holes 757. Because the ionic solution is present inside both holes 757, the electrochemical mechanism produces hydrogen on the lateral surface of holes 757, which prevents the existing plasma inside the cathode from exiting the cathode.

As seen previously, numerous materials for generating plasma solid inside the cathode are unsuitable inside acidic media. For this reason, such materials are completely insulated from the acidic solution by a layer 756 of unimpeachable materials (such as the materials described for the rod 750 (FIG. 8e)).

Also, the electric contact between the end of the rod and the cathode is not always perfect. To improve this electric contact, it is possible to place a small disc made of gold at the bottom of the sustentation hole of the cathode.

In the case of the cubic shape, a second kind of cathode sustentation can be used. At resonance, like the sphere and the cylinder, a cube has a total node at its center of gravity. But at resonance its eight vertices are also total nodes. This property allows a rigid sustentation of the cube through its vertices. This does not impede the vibrations. Two types of sustentation are possible. The first sustentation possibility comprises sustaining the cube through the four vertices of its basis (FIG. 8f). Thanks to the weight of the cathode, the cubic cathode remains on the four supports 750 located at each vertex of the base. The second sustentation possibility comprises sustaining the cubic cathode through its eight vertices, as shown in FIG. 8g. In the two cases, the supports 750 are made of unimpeachable material that also serve to transmit the direct and modulated currents to the cubic cathode. To improve the electric contact between the cube and the supports 750, a layer of gold, platinum, rhodium, etc. can be deposited on the vertices of the cathode.

In the case of the cube, the two kinds of sustentation described previously (sustentation through the center of gravity, and sustentation through 4 or 8 of vertices of the cube) can be used simultaneously. According to this set up, the direct and modulated currents can be applied either through all the contact points with the cathode (center of gravity and vertices) or only through the center gravity using a rod 750 (whose lateral surface is insulated). FIG. 8i illustrates one of these possibilities. Rod 750, whose lateral surface is insulated, penetrates through the top surface of the cube until the rod 750 reaches its center of gravity. Rod 750 supplies the currents to the cathode at the point of contact. With this structure, the ionic solution penetrates inside the hole, filling the interstitial volume located between rod 750 and the cathode. The electrochemical mechanism occurs on the lateral surface of the hole of the cathode. The hydrogen produced in this reaction escapes directly through the hole.

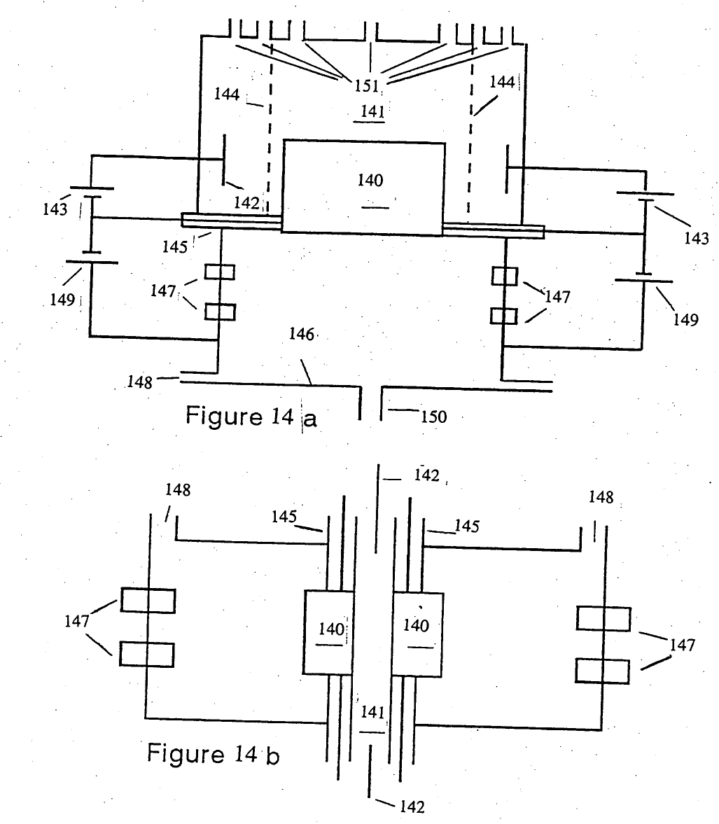

Another possibility of sustentation for the cube, cylinder or parallelepiped comprises immobilizing one of the basis (see FIG. 14a). In this case, the basis becomes a node of vibration.

Inside vacuum (see metal plasma-gas interface in II.B.) or inside an hydrogen atmosphere (see II.C.), the curve of resonance (i.e., amplitude of the vibrations as a function of the frequency) displays a very sharp maximum. The width of the curve at three decibels is only some hertz wide, while the frequency at resonance can reach several kilohertz. In the case of the metal-ionic solution interface, the vibrations of the solid are dampened by the liquid. The curve of resonance (amplitude function of the frequency) is not as sharp as the curves for the other interfaces (metal-plasma gas, and metal-hydrogen). However, the resonance frequency is more cleanly achieved with the cubic electrode upheld through its vertices. For, in this case, the cathode has an optimal shape and is sustained through stable fixed points. Sustaining any cathodes through their center of gravity results in less perfect resonance because the vibrations are slightly perturbed by lateral and axial contacts between the rod and the side of the holes drilled inside the cathodes to reach the center of gravity. The resonance frequency varies with the changes in temperature of the cathode, the aging of the material, the density of plasma, etc. Therefore, the resonance varies progressively. The frequency of the pulsed current is adjusted continuously to maintain the cathode at its resonance frequency. The drift of some hertz from the resonant frequency results in a great decrease in amplitude of the vibrations. Consequently it is difficult to generate the resonance frequency through a separately controlled oscillator. The variation of the vibrations of the cathode themselves are used to control the frequency adjustments. This is achieved by using a self-exciting system to control the vibrations.

(5) Self-Exciting System

The amplitude and the frequency of the vibrations of the cathode can be monitored by using a hydrophone 76 (FIG. 7a) submerged inside the ionic solution, or by using a laser detector (FIG. 7a). The electro-optical system is a high brightness laser pointer 83 that sends a laser ray upon one of the reflecting face of the cathode. The reflected laser ray containing the modulated information (frequency and amplitude) of the vibrations of the cathode goes into an electro-optical receiver 84 (FIG. 7a ), which converts the optical beam of energy into an electrical signal. To avoid the disturbances caused by the bubbles in the ionic solution and at the surface of the ionic solution, the laser ray coming from the laser pointer 83 to the cathode and the reflected ray coming from the cathode to the electro-optical receiver 84 can be conducted through an optic fiber or an isolating plastic tube.

The electric pulsed signal EPS generated by the hydrophone 76 or by the electro-optical system, which monitors the vibrations of the cathode, is then sent to the self-exciting system 82 (FIG. 7a). The purpose of the self-exciting system is to constantly maintain the resonance frequency of the cathode. Different means can be used to maintain this resonance frequency.

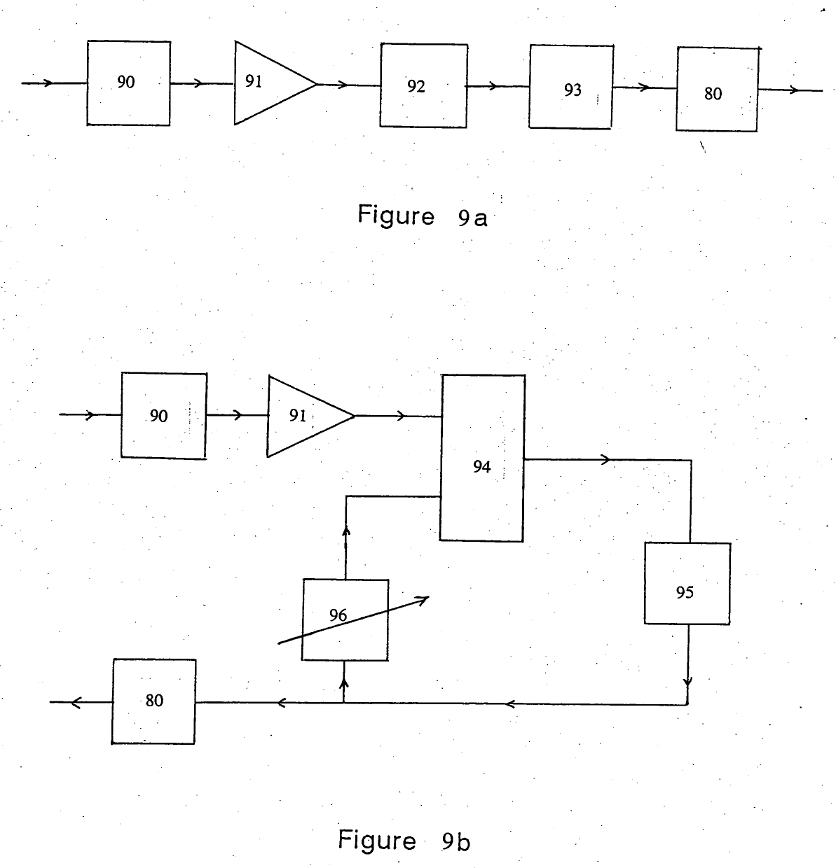

As shown in FIG. 9a, the first means to sustain the resonance through the self-exciting system relies on the fact that the amplitude of the vibrations is at a maximum at resonance. The electric pulsed signal EPS first passes inside the filter 90 to eliminate all the parasite low frequencies. After amplification in amplifier 91, the pulsed signal is then converted into a direct signal by bridge rectifier and filter 92. Afterwards, this direct signal enters into oscillator 93. The exit frequency generated by this oscillator is slaved to the amplitude of the direct signal. The shape of the resonance of the cathode (amplitude of the vibrations function of the frequency) causes the signal exiting the oscillator to remain at the frequency of resonance of the cathode. The signal exiting the oscillator is then sent to power amplifier 80 (FIG. 7a).

The second means to sustain the resonance through the self-exciting system of FIG. 9b is based on the fact that at the resonance for any vibrating system, the exciting signal and the answer of the vibrating system are in phase. As in the previous paragraph, the electric pulsed signal EPS is filtered to remove the low parasite frequencies through filter 90 and amplified inside amplifier 91. The signal EPS has the same phase as the vibrations of the cathode. When the hydrophone is used as detector, it must be placed closely enough to the resonant cathode. But the distance between the cathode and the hydrophone is adjusted so as the signal EPS of the hydrophone and the vibrations of the cathode are in phase. The signal then enters inside comparator of phase 94. A second signal, with a phase of value 0 identical to that of the pulsed current entering the electrolysis (or the electromagnet when used (see later)) also enters the comparator of phase. This second signal comes from the oscillator 95 and passes through part 96, which compensates for the phase delays caused by the amplifier 80 (FIG. 7a) (and the electromagnet when used). Part 96 adjusts its phase to the value of 0. The exit frequency of the signal from the oscillator 95 is slaved to the signal coming from the comparator of phase. The selected frequency is that of the resonance of the cathode. The signal generated by the oscillator, then goes to the power amplifier 80 (FIG. 7a).

A self-exciting system can also be created by converting the electric signal coming from part 92 (FIG. 9a) or the signal coming from the comparator of phase 94 (FIG. 9b) to digital form and feeding the signal to a computer. The computer can then command a programmable oscillator to follow the frequency of resonance of the cathode.

The different systems used to excite the cathode (e.g., pulsed current, electrodynamic means, magnetic field, etc.) (see, for example, following section) operate at maximum efficiency if the vibrations of the cathode are maintained at resonance. At resonance, it is possible to obtain vibrations of large amplitude using a minimum amount of energy. However, even when using frequencies close to the resonance frequency, the vibrations are still large and synchronized enough to create plasma solid, provided that the amplitude of the vibrations are at least one-fifth (⅕) of the amplitude of the vibrations at resonance.

(6) Other Methods Used to Induce Vibrations in the Cathodes

(a) Vibrations Induced Through Electrodynamic Means

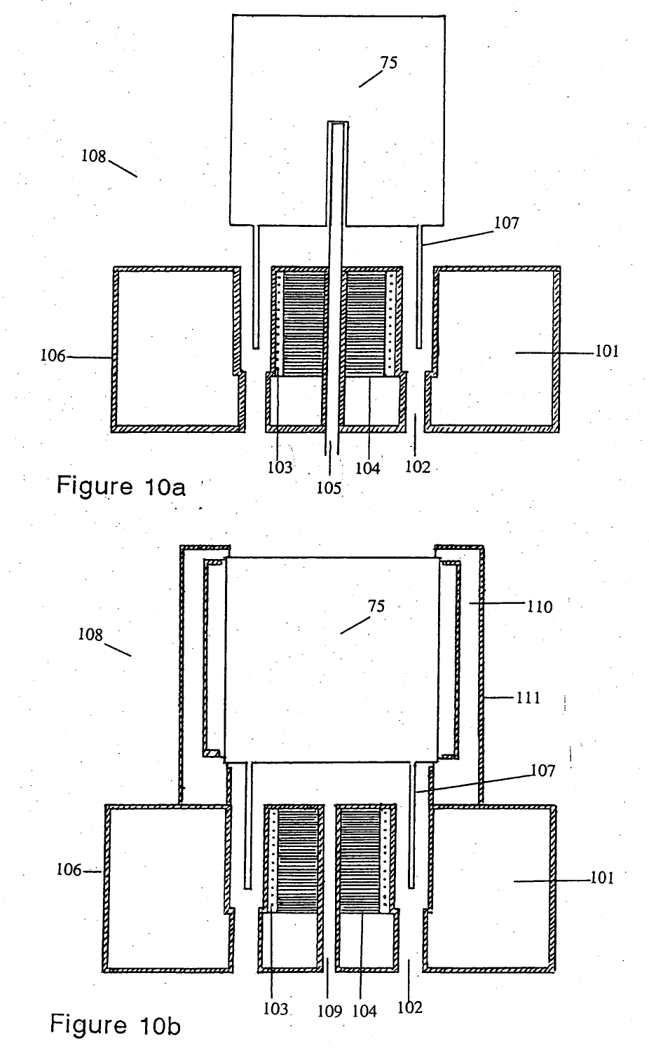

The purpose of these methods is to create the vibrations directly inside the cathode material through electrodynamic means. A first embodiment uses a loud speaker-like instrument in which the cardboard cone has been replaced by a full metallic solid (e.g., sphere, cube, cylinder) vibrating, as in the previous paragraphs (FIG. 10).

Turning to FIG. 10a, the vibrator of this first embodiment comprises (a) a magnetic member selected from a magnet and electromagnet 101; (b) a central pole of the magnet made of laminated metal 104; (c) a coil 103 at the periphery of the central pole creating an alternative magnetic field; (d) a rod or support 105, preferably made of unimpeachable material crossing the central pole of the magnet 101 through its axis of symmetry; (e) insulation 106, preferably made of silicone or other material inert in acid solutions, covering the vibrator to prevent any contact between metallic parts of the vibrator, the acid solution 108, and the rod 105; (f) one or more passages (e.g., holes) 102 at the basis of the magnet for allowing the free flow of the acid solution through the magnet; and (g) a cathode (e.g., cube, cylinder, sphere) 75 with a cylindrical ring 107, preferably made directly in, i.e., integral with, the mass of the cathode. The role of the cylindrical ring is identical to that of a mobile coil in a loud speaker.

The solid cathode (e.g., cube, sphere, cylinder) with the ring 107 is sustained freely through its center of gravity by a metallic rod 105 made of the same unimpeachable materials described previously. The direct current arrives to the cathode through the rod 105. This mode of sustentation removes any impediment to the longitudinal and radial vibrations of the cathode. The material of the cathode is made of a non-magnetic metal so that the magnet or electromagnet does not impede the vibrations. The cathode material also is a good electric conductor with low internal friction and vibration dampening properties. The cathode is sustained through its center of gravity. In this position, the ring made directly in the mass of the cathode is located under the lower surface of the cathode. This cylindrical ring penetrates in the cylindrical air gap of the electromagnet without touching the sides of the electromagnet. The power amplifier 80 supplies alternative currents to the fixed exciting coil 103. These currents induce very intense alternative currents inside the ring of the cathode and inside the cathode. These intense currents in the magnetic field produced by the magnet or electromagnet cause the cathode to vibrate. The central pole 104 of the electromagnet is laminated to reduce eddy currents. The resonance of the cathode is controlled and maintained by using the same self-exciting system described previously. Holes are drilled in the ring directly at the junction of the ring and the cathode itself. The holes permit the escape of hydrogen produced by the part of the cathode that is inside the ring.

If the cathode is shaped as a cube (FIGS. 8f and 8g), the cathode can be sustained through four of its vertices or through all eight of its vertices. The vibrator of FIG. 10b is identical to the one described in FIG. 10a except for rod 105. The cubic cathode with its cylindrical ring penetrating in the cylindrical air gap of the electromagnet is sustained through its vertices on supports 110 (FIG. 10b). The direct current directed to the cathode passes through the metallic supports 110 to the vertices of the cathode. These supports 110 are made of unimpeachable material, like rod 105. A hole 109 drilled inside the central pole of the magnet can be used to allow the passage of the ionic solution through the magnet. The sides of the hole are insulated to prevent any contact between the solution and the central pole. The ionic solution under the cathode inside the ring is thus better renewed, as a consequence of this hole. The flow of the solution through the central pole also cools the electromagnet. As in the previous paragraph, holes are drilled in the ring of the cathode to allow the escape of hydrogen. To increase the resonance, the cathode can be placed inside a tuned enclosure reflecting the waves to the lateral faces. The distance between the walls of the enclosure and the faces is set equal to a quarter of the wave length, i.e., λ/4 or k λ/2+λ/4, where k is a whole number. The enclosure has holes drilled through to allow both the escape of hydrogen and the continuous renewal of the acid solution coming in contact with the cathode.

The cylindrical ring 107 made directly into the mass of the cathode is part of the cathode. When the cathode is submerged inside the acid solution, the surface of the ring 107 is also used for the electrochemical mechanism of hydrogen production. The ring 107 is thin and its volume is small. But the area of the ring in comparison with the area of the cathode is not negligible. Consequently, an appreciable part of the total current is diverted to the ring 107. This portion of the current cannot be used to create plasma solid inside the larger part of the cathode (e.g., cube, sphere, cylinder). To prevent this loss of current, it is possible to deposit a small layer of silicone (or, e.g., polyvinyl, polyethylene, polypropylene) on the ring surface to insulate the ring from the acid solution. The current is thus used solely for the creation of plasma inside the larger part of the cathode (e.g., cube, sphere). The insulation of the ring has another advantage. The production of hydrogen on the ring 107 creates over pressure of hydrogen in the small cylindrical air gap of the electromagnet. The over pressure damages the ring when the material is fragile. The insulating layer protects the ring, prevents its degradation, and makes the process more efficient.

In the case where the cube is sustained through its eight vertices (FIG. 10b), the positions of the ring and the electromagnet can be inverted. Instead of being under the cathode, the ring and electromagnet can be placed above the cathode. With this structure, the electromagnet is not immersed inside the solution. The direct current can also be supplied to the cube through its center of gravity.

(b) Vibration Induction by use of Magnetic Field

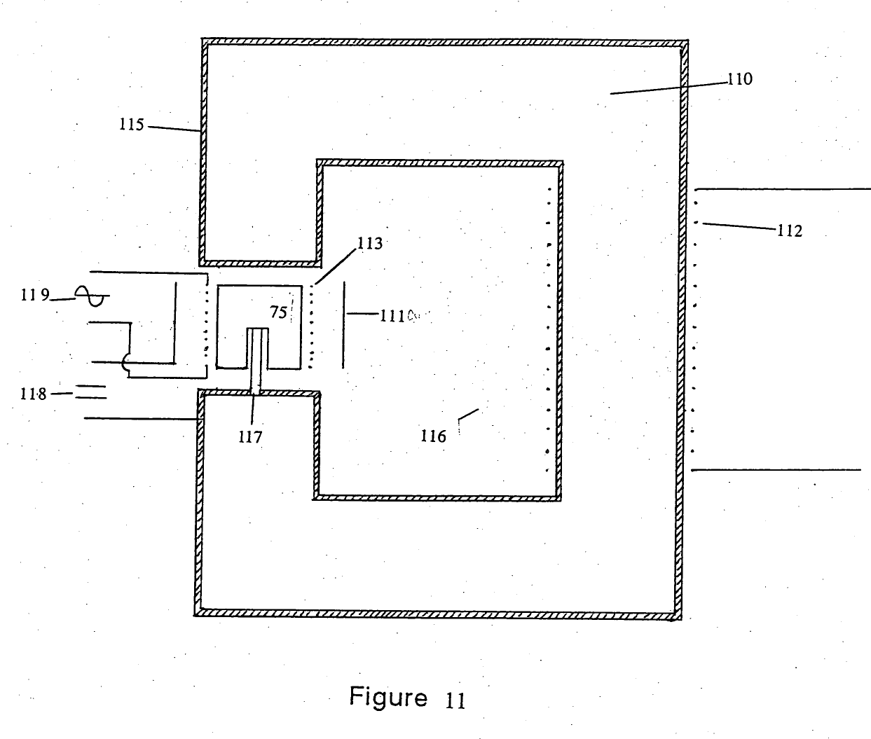

Another method that can be used to induce vibration of the cathode is to place the cathode (e.g., the cube, cylinder, sphere) inside an intense constant magnetic field to which is superposed an alternative magnetic field. This vibrator, an embodiment of which is illustrated in FIG. 11, comprises (a) a magnetic member 110 (e.g., a magnet and/or an electromagnet) with its coil 112; (b) an auxiliary coil creating the alternative magnetic field 113 due to a source of alternative current 119; (c) a solid cathode 75 sustained through its center of gravity by rod 117 or in the case of a cube by its vertices; (d) insulation of the electromagnet 115; and (e) an ionic solution 116.

As described in previous embodiments, the cathode is sustained through its center of gravity by a rod. The rod is affixed to the electromagnet. The remarks about the nature and the shape of the cathode, the rod, and the vertices for the cube previously described remain valid in this case. The currents induced (eddy currents) in the cathode are concentric to the axis of the cathode. Under the influence of the constant magnetic field parallel to the axis, the eddy currents generate radial alternative forces. These forces provoke dilations and contractions of the cathode. The cathode vibrates at the same frequency as the alternative current of the auxiliary coil 113. A flow of ionic solution crossing the auxiliary coil constantly renews the solution in contact with the cathode. The wires of the coil are electrically insulated to avoid contact with the solution. As described previously, the direct current for the cathode arrives through the rod 117 or the supports in contact with the vertices with the cube. A power source 118 supplies the direct current between the cathode 75 and the concentric anode 111. The same self-exciting systems described previously are used to maintain the resonance frequency of the cathode.

(c) Excitation by Quartz or Magnetostriction Transducer

Affixing a quartz or a magnetostriction transducer to one of the bases of the cathode is another means of inducing vibrations of the cathode. The vibrations of the transducer can also be transmitted to the cathode through the rod 750 which sustains the cathode through its center of gravity (FIG. 8) or through the vertices in the case of a cubic cathode (FIG. 8).

(d) Simultaneous Use of the Methods of Vibration

The magnetic methods used to induce vibrations of the cathode can be used simultaneously with a pulsed current in the ionic solution. The alternative currents used with the magnetic method, and the modulated current used in the solution have the same frequency. A phase shift control device 85 (FIGS. 7a and 7b) at the exit of amplifier 80 controls perfectly the addition of the two vibrations. In the specific case of the double rectified alternative current, the bridge rectifier doubles the frequency of the modulated current. The frequency of the modulated current is brought back to the same value as the alternative current used in the magnetic vibrator. For this purpose, a divider device 86 (FIG. 7a) that halves the frequency is positioned at the exit of the amplifier 80. This device allows the frequency of the modulated current to be restored to its correct value.

All these vibration methods allow the storage of plasma inside the core of the cathode. The loading of the cathode by use of high current density and vibrations of high amplitude is achieved more quickly. When the cathode's storage has reached its maximum capacity (i.e., the quantity of plasma that can be stored without incurring damage to the electrode), it becomes possible to decrease the current density and the amplitude of vibrations. However, a minimum level of vibrations is then maintained continuously to keep the H D T⁺ under the form of plasma.

Of note, if the resonance vibrations become too large, the materials that make up the cathode are damaged. In the case of the sphere, cube or cylinder, the stress concentrates at the center of gravity. When vibrations of large amplitude (e.g., a tenth of mm) are used, the rupture threshold of the material that make up the cathode can be overstepped. Plastic deformation surrounding the center of gravity can extend over large areas. This results in a loss of performance of the cathode: diminution of the maximum amplitude of the vibrations, decrease of the resonance frequency, and widening of the resonance.

In the case of the cube, the sustentation through the center of gravity and through the vertices can be used simultaneously. All the contacts points of the cathode (center of gravity and vertices) can be used for the transfer of the currents to the cathode.

(7) Temperature

The increase of temperature provokes a large dissociation of the acids inside the solution. The concentration of the H D T⁺ ions augments. The resistivity of the solution diminishes. It becomes easier to accumulate more H D T⁺ more closely to the surface of the cathode and inside the cathode in the form of plasma. The increase in temperature of the electrode can have two effects: First, a high temperature allows the metal of the electrode to soften, and therefore increases the level of vibrations of the electrode. Second, when energy is produced through plasma solid fusion, the thermal efficiency of the power reactor is directly related to the temperature of the solution. A high electrode temperature is accompanied by a high ionic solution temperature. Since the solution is a carrier of the heat generated by the electrode, the high temperature increases the thermodynamic efficiency of the system. As the solutions are aqueous, it is desirable to work with high pressures to obtain high temperature and keep the solutions in a liquid state. It is possible to use a range of temperature-pressure from, for example, about 300° C.-8 Megapascal to about 600° C.-30 Megapascal, as found, for example, in actual pressurized power plants.

II.B. Creation of Plasma Solid using Plasma Gas

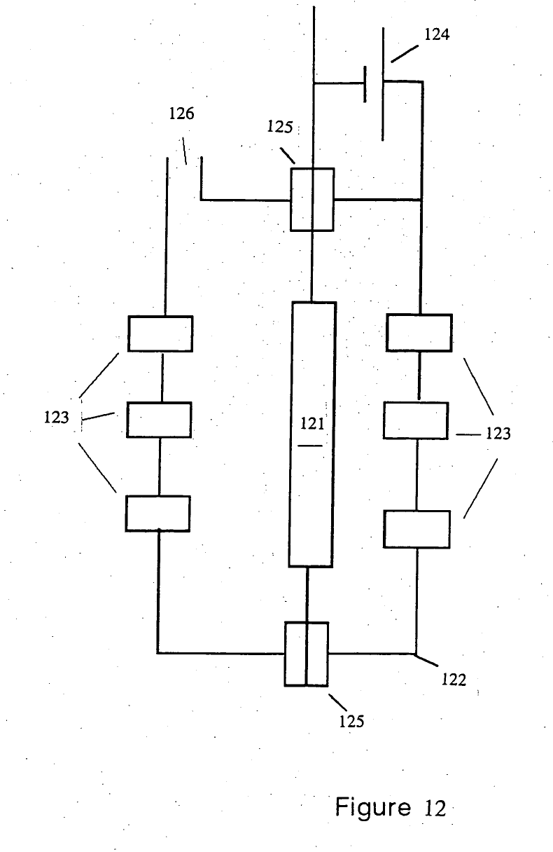

The plasma inside a solid can be created with H D T⁺ coming from a plasma gas. The interface metal-plasma gas can be realized in an apparatus of the type described in FIG. 12. The cathode (121), composed of palladium, palladium-like alloys already described, or the other elements or alloys previously described in Part I.C. is positioned at the center of the enclosure (122). The enclosure (122), a metallic or electrical conductor concentric in shape (or other), is used as the anode.

The plasma injectors (123) are distributed uniformly on the surface of the enclosure (122). The injectors are of the model found in the literature. The injectors can be, for example, a molecular hydrogen stream subjected to electrical discharges (the discharges break the hydrogen molecule into H D T⁺ and electrons). The breaking of the hydrogen molecules into plasma can also be achieved by increasing the temperature, by using lasers, and electromagnetic fields, etc. A power source (124) applies a potential difference between the cathode and the anode. This allows the attraction of the H D T⁺ to the cathode. Non-conductors (125) are placed in positions to avoid any contact between the wire leading to the cathode and the enclosure. A cavity for accommodating a vacuum pump (126) allows the removal of the hydrogen molecules which have not been broken down by the electrical discharges or which appear at the surface of the cathode. Also, the cavity allows a vacuum to be maintained inside the enclosure. The voltage applied between the anode and the cathode is adjustable and can be much higher than the voltage used in the metal-ionic solution. The voltage is pulsed at the resonance frequency of the electrode, so as to create stationary waves inside the cathode. The vibrations of the electrode are as important as in the case of an ionic solution. The vibrations allow the plasma created inside the active layer to disperse quickly in the core of the electrode and in the unused part of the layer, and allow the plasma to remain stable, for plasma storage or for other applications. Since there is a potential difference between the cathode and the anode, there can be no stable plasma concentration between the two electrodes. However, the plasma flow from the injectors (123) should be considered as more important. The plasma flow from the injectors can be pulsed at the same frequency as the voltage so as to provoke vibrations inside the electrode. Pulsing may be performed using techniques described herein.

The methods used to cause vibrations of the cathode 121 described above in connection with the ionic solution also can be used with plasma gas. All the above remarks describing the methods and processes and vibration induction with magnets and electromagnets, the nature of the cathode (e.g., shape, cube, sphere, cylinder), methods of sustentation of the cathode by a rod in the center of gravity or by its vertices for a cube or fixed by one of its basis, the different self-exciting systems, etc. are valid and are fully applicable in the case of a metal-plasma gas interface.

The metal-plasma gas interface has other interesting uses. Numerous materials that can be used to produce plasma solid suffer from corrosion and degradation in acid solutions. When using an ionic solution, the materials are protected by placing a layer of an unimpeachable metal between the material surface and the solution. Using these materials in a vacuum with the presence of plasma gas obviates this drawback. The materials can be used directly without any protection. Another advantage with the metal-plasma gas interface is that the vacuum surrounding the solid does not dampen the vibrations of the solid. Resonance can be achieved using a small quantity of energy. The curve of resonance (amplitude of the vibrations function of the frequency) displays a very sharp maximum. The width of the curve at three decibel is only some hertz wide, while the frequency at resonance can reach several kilohertz.

Using the metal-plasma gas interface method also allows the use of cations which do not exist in ionic solutions. One of the most interesting of these cations is He²⁺. Among the He²⁺ ions, isotope three is the most interesting for thermonuclear fusion reaction. It is also possible to use a mixture of H D T⁺ and He²⁺.

II.C. Creation of Plasma Solid using Hydrogen Gas

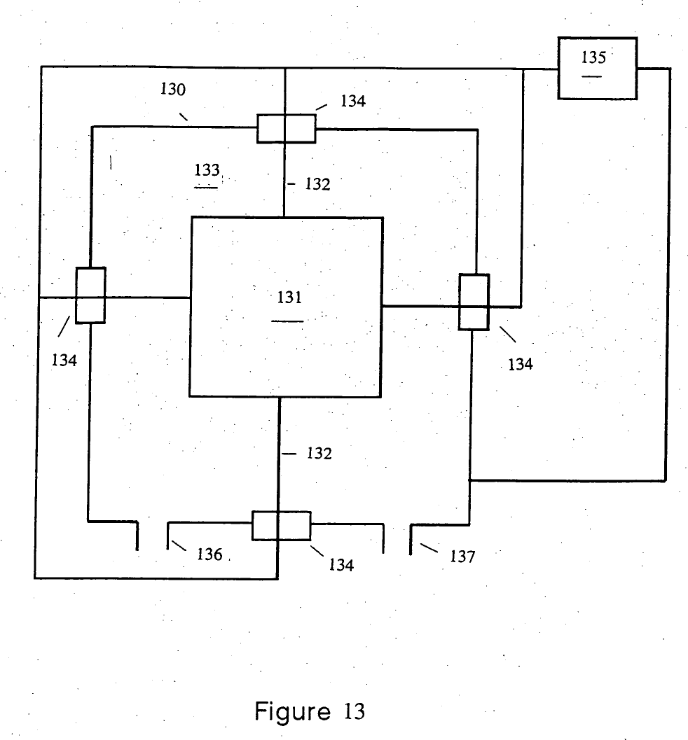

FIG. 13 represents another method to create H D T⁺ plasma inside a cathode 131. This cathode is made of the elements, materials or alloys already described in part I.C. The cathode is placed inside a metallic enclosure 130 containing a hydrogen atmosphere 133. The hydrogen pressure is maintained at a constant level by addition of hydrogen through the hole 136 during the loading of the cathode. The cathodes are shaped as previously described: cube, cylinder, sphere, etc., with a cylindrical ring made directly into the mass of the cathode. The cathode 131 is sustained through its center of gravity by rod 132. The rod is affixed to the central pole of the electromagnet. A cubic cathode can also be sustained through its vertices. Reference numerals 134 represent non-conductors. During the loading phase, the rod 132 is connected to the negative pole of an electric power source 135. This source maintains a difference in potential between the cathode 131 and the enclosure 130. This difference in potential is the addition of a constant potential to a pulsed potential. Electric discharges through the hydrogen atmosphere are created between cathode 131 and anode 130. The surface of the enclosure 130 is covered with numerous spikes directed to the cathode. These spikes facilitate the discharges. Along trajectory of the discharges, the H₂ molecules are broken apart and become a plasma of particles HDT⁺ and electrons. Because of the electric field, the HDT⁺ particles are attracted to cathode 131 and penetrate inside.

The vibrations of the cathode 131 are induced by the coil affixed to the electromagnet as described previously in part II.A. (e.g., detection of the vibrations by laser device or microphone, transmission of the signal to the self-exciting system, alternative signal to power amplifier and then to the fixed coil of the electromagnet). This process produces vibrations of large amplitude by maintaining the cathode at resonance. All the elementary cells of the cathode 131 are filled progressively with hydrogen atoms and a plasma of particles (HDT⁺ and electrons). These particles, subjected to the vibrations of the metal, remain under the form of plasma (or plasma solid). Depending on the material used for the cathode, the elementary free space is more or less conducive to the creation of plasma (as seen in the part I.C.). The generation of plasma by using hydrogen molecules is more difficult than when using either an acid solution or a plasma gas.

The release of the hydrogen through hole 137 can be accelerated by polarizing positively cathode 131 in comparison to enclosure 130 using electrical power source 135. This apparatus can also be used to create He²⁺ plasma crowns in the metal or alloy with the proper resonant cavities from a helium atmosphere or from a mixture of helium and hydrogen atmosphere.

II.D. Creation of Plasma Solid with Simultaneous Release of Plasma from the System

In the previous interfaces (e.g., metal-ionic solution, metal-plasma gas, metal-hydrogen gas), the mechanism works by first loading the plasma, then, in a second period, releasing it. The interest of a double interface, or mixed interface, is to separate the two functions so as to be able to use them both at the same time. Plasma loading can be conducted using an ionic solution in one compartment. It could occur continuously. The release of the plasma through the second compartment is conducted under the control of a power source. The second compartment can be filled with ionic solution, plasma gas, hydrogen gas or vacuum. FIG. 14a describes a mixed interface (metal-plasma gas)-(metal-ionic solution).

The cathode is placed at the interface between two compartments. The first compartment holds an ionic solution, the second a plasma gas. The cathode (140) is made of a metal or alloy already described in part I.C. One side of the cathode is in contact with the ionic solution (141). The cathode can then be loaded with plasma through the surface in contact with the ionic solution. The other side of the cathode belongs to the second compartment.

The ionic solution is in constant movement. The ionic solution (141) enters and departs through the tubes (151) so as to maintain a constant pH at the surface of the cathode. The flow of the ionic solution also allows for the removal of the hydrogen molecules created by the cathode. The anode (142), made of a noble metal or of an alloy that does not pollute the cathode, is separated from the cathode (140) by a porous membrane (144) to avoid the mixing of oxygen or chlorine and hydrogen. A power source (143) maintains a current density flow composed of two elements, a continuous current density and a pulsed current density, which allows the plasma loading of the cathode from H D T⁺ in the ionic solution. Part 145 is a non-conductor through which the wire that establishes the electric contact between the cathode and the two power sources passes. The non-conductor (145) constitutes the separation between the two compartments. Part (145) also allows the two extremities of the cathode to be maintained in a fixed position and the characteristics of the stationary waves to be determined with exactitude. Other fixtures at the nodes of vibration can be installed.

The second compartment is the same as the one described in the previous section: enclosure as anode (146), plasma injector (147) cavity for vacuum pump (148), a power source (149). The function of the second compartment is variable with time and depends of the chosen application.

When the use of the plasma solid is not necessary, the power source (149) which produces pulsed current-density at the same frequency as in the first compartment, and the plasma flow created by the injectors are maintained at the lowest possible levels to avoid the departure of the plasma solid from the cathode. The potential delivered by power source (149) is adjusted to a sufficient value to prevent the plasma from leaving the cathode.

When it becomes necessary to use the plasma solid, the potential of the power source (149) allows the discharge of the plasma through exit 150 to be controlled. At the same time, the injectors (147) are stopped. Another interesting use for this double interface could be the use of another configuration (FIG. 14b): the ionic solution passes through the cathode while the different compartments retain their own function. The flow of ionic solution allows the control of the temperature of the cathode and the transfer of heat generated inside the cathode. The second compartment can be filled with vacuum or hydrogen gas. In this system, all the methods of vibration production described in part II.A. can also be used.

II.E. Plasma Solid Composed of Particles Other Than H D T⁺

As explained previously, materials with free interstitial volume close to that of palladium generate the best conditions to create plasma solids. However, even if these conditions are not met, it is still possible to use any kind of electric conductor as the cathode in the process. But because of the gross lack of efficiency, the creation of plasma solid requires more energy and vibrations of larger amplitude.

This method for producing a plasma of H D T⁺ can be generalized to the elements close to the size of hydrogen: helium, lithium, beryllium, boron, etc. The size of the ions available in ionic solution Li⁺, Be⁺⁺, B⁺⁺⁺ are much larger than the size of H D T⁺. They cannot penetrate inside the cathode. Furthermore, ions He⁺ do not exist in solution. Production of plasma solid with these elements is only possible with the ions He²⁺, Li³⁺, Be⁴⁺. . . . These ions are the nuclei of the corresponding atoms. They can be obtained only by using plasma gas. In gaseous form, these elements are stripped of all their electrons by electrical discharge. They become plasma of nuclei. The method used to create plasma solid from H D T⁺ (described previously in part II.B.) can also be used with these nuclei. Under the influence of an electric field, they move to the metal cathode where part of them penetrate inside to become plasma solid. However these nuclei He²⁺, Li³⁺, Be⁴⁺ . . . carry several positive electric charges. They thus attract electrons with considerable force. To prevent these nuclei from reacting with the electrons surrounding them, very efficient conditions and specific materials are used to preserve these ions under the form of nuclei in the plasma solid. The smallest (closest to the size of each respective ion) free elementary interstitial volume is best. Some volumes are particularly favorable. In the case of helium, the resonant cavities necessary to keep the He²⁺ ions in the form of plasma have the approximate size of a He⁺ ion. For lithium, the free elementary cell needed to preserve the Li³⁺ ions under the form of plasma have about the size of the Li²⁺ ions. With the Be⁴⁺ and B⁵⁺ ions, the free elementary cavities to retain these ions under the form of plasma of nuclei have about the size of the Be³⁺ ions and the B⁴⁺ ions, respectively. The efficiency of these different plasma cavities is increased by applying vibrations of large amplitude. The methods required to generate vibrations have already been described previously in part II.A. These methods are fully valid and applicable here. These plasma can also be stabilized more efficiently by using mixtures of plasma H D T⁺ with He²⁺, H D T⁺ with Li³⁺, H D T⁺ with Be⁴⁺ and H DT⁺ with B⁵⁺. Any mixtures of the ions cited in this part, can be further mixed with H D T⁺ to form usable plasmas. All these different types of plasma can be used to generate plasma solid fusion.

II.F. Release of the Plasma

The plasma is capable of storing matter, electrical charges, and energy. By varying the potential applied to the cathode, the H D T⁺ appear under the form of charged particles or of molecules, depending on the nature of the compartment in which the release occurs.

III. Plasma Solid: Applications and Use

The plasma solid contained in specially designed materials and submitted to controlled vibrations can be used in different ways. If the amplitude of the vibration only reaches the limit needed to prevent the reaction of H D T⁺ and electrons, the cathode can be used to store energy or matter. If the amplitude of the vibrations is larger, the H D T⁺ will interact together and provoke a thermonuclear fusion or a plasma solid fusion. The interaction will extend beyond the interaction of plasma particles to the interaction of the H D T⁺ with nuclei of the metallic atoms.

III.A. Storage of Energy.

As seen previously, the plasma composed of H D T⁺ and electrons is located inside the elementary free volume of the cathode. The shape of the space where the plasma can be found is a complex volume and changes constantly because of the vibrations of the metallic atoms. However, it can be simplified to a spherical crown at the outer periphery of the elementary cell. Both the metallic structure of the cathode and the plasma solid are stable. Under these conditions, the plasma solid can be used for the storage of energy, electrical charges, or matter. The plasma can reach a concentration between 10²³ and 10²⁴ particles H D T⁺ per cubic centimeter of cathode.

This high density plasma solid constitutes a storage of energy under two forms:
The H D T⁺ and electrons are kept separated inside the plasma. When the particles are allowed to leave the cathode, they associate to produce molecular hydrogen and an energy of 31.3 eV per molecule of H₂ or an energy of 3×10³ kilojoule/mole of H₂. This constitutes the plasmatic energy of the plasma solid.
Then the combustion of molecular hydrogen with oxygen produces an energy of approximately 250 kilojoule/mole of H₂. This part is the chemical energy of combustion.

The total energy stored per mole of H₂ under the form of plasma is about 3.25×10³ kilojoule/mole of H₂. By comparison, gasoline produces about 5×10³ kilojoule/mole or 35×10³ kilojoule/dm³ of gasoline, or in a tank of 60 cubic decimeter, about 2×10⁶ kilojoule. To obtain the same reserve of energy in the form of plasma solid, it is necessary to store about 650 moles of H₂. With a concentration of 2×10²³ H⁺.cm⁻³ inside the cathode and an utilization rate of 50% of the cathode by using stationary waves, the concentration of plasma is therefore 10²³ H⁺ per cubic centimeter of cathode. Inside a single cm³ of cathode, 5×10²² molecules of H₂ or 8×10⁻² mole of H₂ can be stored. The 650 moles of H₂ can be held inside eight cubic decimeter of cathode. This volume can be reduced by using a larger concentration of plasma and a greater rate of utilization of the cathode. The plasma solid allows the storage of a great amount of energy in a small volume, and therefore increases tremendously the autonomy of any vehicle. This energy could be used inside a turbine.

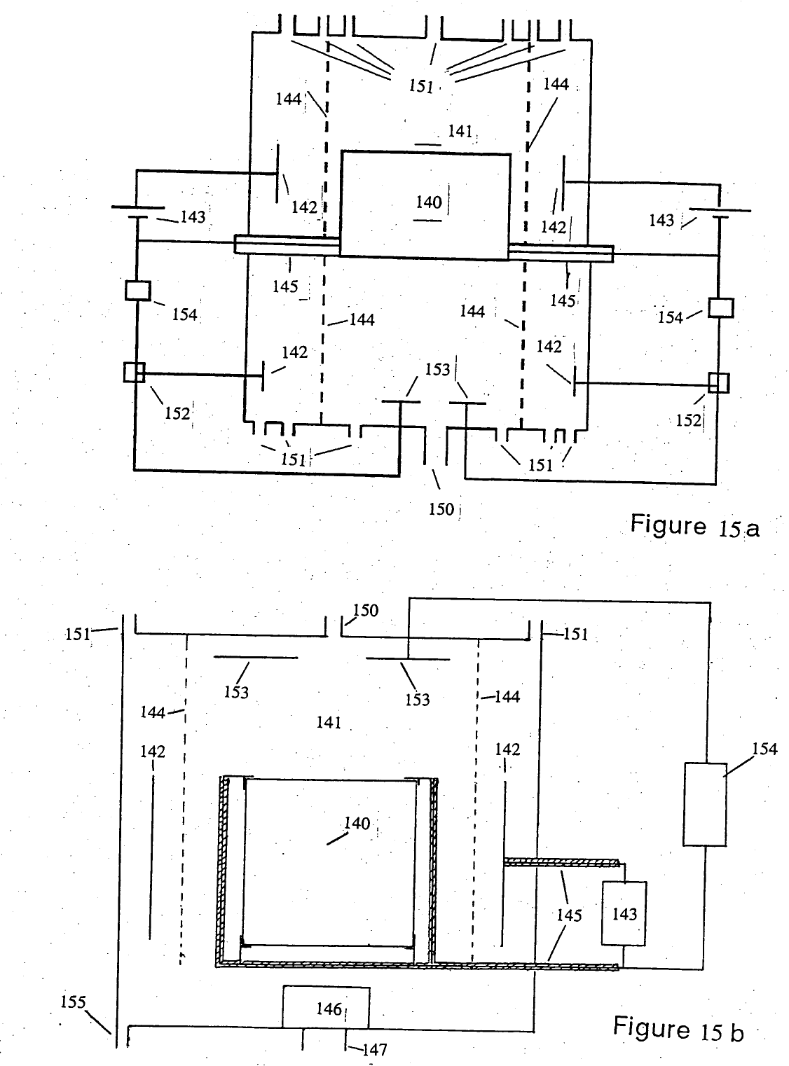

FIGS. 15a and 15b present a possible use of plasma solid for the storage of energy. The cathode containing the plasma solid is included between two compartments (FIG. 15a).

The first compartment is the same as the one described in FIG. 14a. It contains the same parts: cathode (140), ionic solution (141), anode (142), power source (143) (including direct current and pulsed current), porous membrane (144), and non conductor (145) to separate the two compartments with an electrical wire passing through to establish a contact between the electrode and the power source. Tubes (151) are used for the circulation of the ionic solution. The functions of the first compartment are the loading of plasma overnight and, due to power source (143), the continuous creation of a state of vibration that maintains the plasma within the cathode.

The second compartment has two functions:
The first function of this compartment is to prevent the escape of plasma from cathode (140) when there is no need for energy. To accomplish this function, the second compartment is filled with an ionic solution. The polarities of electrodes (140) and (142) are the same as the one described for the first function. The difference in potential allows the user to maintain or increase the concentration of plasma already inside the cathode through the surface of the second compartment.
The second principal function of the second compartment is to allow the departure of plasma. At first, the ionic solution is completely emptied from the second compartment through tubes (151), which are closed once the operation is completed. Only tube (150) remains open. Switch (152) disconnects the anode (142) and connects electrode (153) to the power source (154). This power source provides a negative potential to electrode (153) when compared to electrode (140). Because of the difference in potential, the H D T⁺ can leave electrode (140), then react with electrons at the surface of electrode (153) to become molecular hydrogen. Some hydrogen molecules may leave electrode (153) with negative charges which are neutralized by H D T⁺ coming from the opposite direction. The second compartment then fills with H₂. The reaction energy appears simultaneously (2H⁺+e⁻→H₂+31.3 eV). The pressure of molecular hydrogen increases and a flow of hydrogen with plasmatic energy leaves the second compartment through tube (150) to set a turbine in motion. This hydrogen itself can be burned in the same turbine or stored to supply a fuel cell. An alternator coupled with the turbine produces the electricity required to supply the electric motors of cars or trains. In the case of an airplane, the flow of hydrogen can directly supply a turbojet. Thus, such a double compartment is interesting because it allows the separation of loading and unloading between the first and second compartments, and the control, due to the applied potential difference, of the flow of molecular hydrogen. The use of plasma solid will have many beneficial consequences, especially for the environment.

FIG. 15b presents an alternative system to the system presented in FIG. 15a. The cathode 140 inside the acid solution 141 is one of the cathodes described in FIG. 8 or FIG. 10. The cathodes are cubic, cylindrical, or spherical in shape. The cathodes depicted in FIG. 10 have a cylindrical ring made directly into the mass of the cathode. The cathodes can be sustained through their center of gravity or through their vertices (in the case of the cube). The direct current and the modulated current passing between the cathode 140 and the concentric anode 142 are provided by power system 143. The frequency of the modulated current is regulated by one of the self-exciting system already described. The vibrations inside the cathode can also be created by using an electromagnet 146. A power source 147 slaved to a self-exciting system supplies the alternative current to the electromagnetic system. The methods and systems used to create and maintain the plasma solid inside these cathodes are identical to those described previously in part II.A. A porous membrane 144 allows the separation of the gas produced during the electrolysis. These gases escape respectively through the holes 150 and 151. Hole 155 regulates the level of the ionic solution. When the level of the solution is lowered, the upper part of the cathode is no longer in contact with the ionic solution. The plasma solid can escape from the cathode through this freed surface and becomes molecular hydrogen. The quantity of plasma escaping from the cathode will vary with the area of the free surface. It is also possible to regulate the exit of plasma with the power source 154. The power source 154 provides an adjustable difference of potential between concentric electrode 153 and the cathode 140 which can accelerate, slow down or stop the flow of plasma. The plasma energy appears during the conversion of the plasma into molecular hydrogen. This energy elevates the temperature of the gas and creates an over pressure in the flow of hydrogen which exits through the hole 150.

In the two systems described (FIGS. 15a and 15b) hydrogen is produced constantly at the surface of the cathode. This continuous creation of hydrogen prevents the plasma solid from leaving the cathode. The hydrogen is continually recuperated and recycled under the form of energy, e.g., by using either a fuel cell or turbine.

Reloading the cathode or plasma solid container used to power the vehicles when the container becomes empty can be achieved through at least four different manners:
1) Reloading under a low voltage and a high current density through a reloading system (e.g., power supply, modulated current, electromagnetic system of vibration, self-exciting system). The reloading is conducted while the vehicle is idle or unused (e.g., overnight in a garage for example).
2) Replacement of the plasma solid container. Once empty, the standard plasma solid container can be exchanged at a loading station where standard plasma solid is refilled and stored. Plasma solid containers of different standard sizes will be devised to meet the energy requirements of different vehicles.
3) Almost instantaneous reloading of the plasma solid container at plasma reloading station. The system described in FIG. 15a is a close version of the reloading system needed in these stations. The reloading system has the two same compartments as the one depicted in FIG. 15a, but these compartments are reversed. The first compartment of the cathode 140 is located at the bottom and the second on the top. The holes 151 located in the first compartment (for the gas H₂ and O₂) are placed differently. The first compartment is identical to the one described in FIG. 15a. The function of the first compartment is to load plasma continuously into the large cathode 140. The second compartment is filled with ionic solution. The empty cathode is affixed by one of its basis to the basis of the larger cathode 140, which is filled with plasma solid. The bases of the two cathodes are static. The two cathodes are under potentials and both are receiving electric currents. A direct current and a modulated current are applied between the empty cathode and anode 142. These currents induce the empty cathode to vibrate at one of its resonance frequencies. The cathode begins to store plasma. This frequency can be different from the resonance frequency of cathode 140. Because of the state of vibrations, the empty cathode can receive a transfer of plasma solid from the cathode 140 full of plasma solid, and generate plasma from the ionic solution from the other sides. The plasma contained inside the large cathode moves easily inside the empty cathode. Since the large cathode used in the reloading station is much larger than the standard cathode, the plasma solid concentration inside the large cathode does not vary significantly. The standard cathode is thus loaded rapidly at the same concentration. After reloading, the standard cathode is transferred to the vehicle, while remaining inside the ionic solution and under the current provided by the vehicle so as to avoid the escape of plasma from the cathode during the transfer. The quantity of plasma solid transferred can be measured simply by weighing the mass of the cathode before and after the loading.
4) Using a reloading system identical to the one described in FIG. 15b is another possibility. The cathode 140 is cubic or square parallelepiped. The cathode 140 has the same square cross section as the empty standard cubic plasma solid container. Further, in the case of the parallelepiped cathode, the length is a multiple of the length of the side of the basis. As described in the previous paragraph, the cathode 140 is loaded continuously. The empty cathode is affixed to the top of the cathode 140. The two are held together through the vertices of the combined (cathode 140+standard cathode) system. Because the cross section of the cathode 140 and the standard cathode are identical, the resonance frequency of the standard electrode is also a resonance frequency for the combined system of electrodes. As it is saturated, the cathode 140 quickly discharges a part of its plasma solid load into the standard cathode. This equalizes the plasma density throughout the combined system. The system is then broken up and the standard container is separated. While under electric power and in ionic solution, the standard cathode is transferred by manipulation of its vertices into the vehicle.

III.B. Storage of Matter and Charged Particles

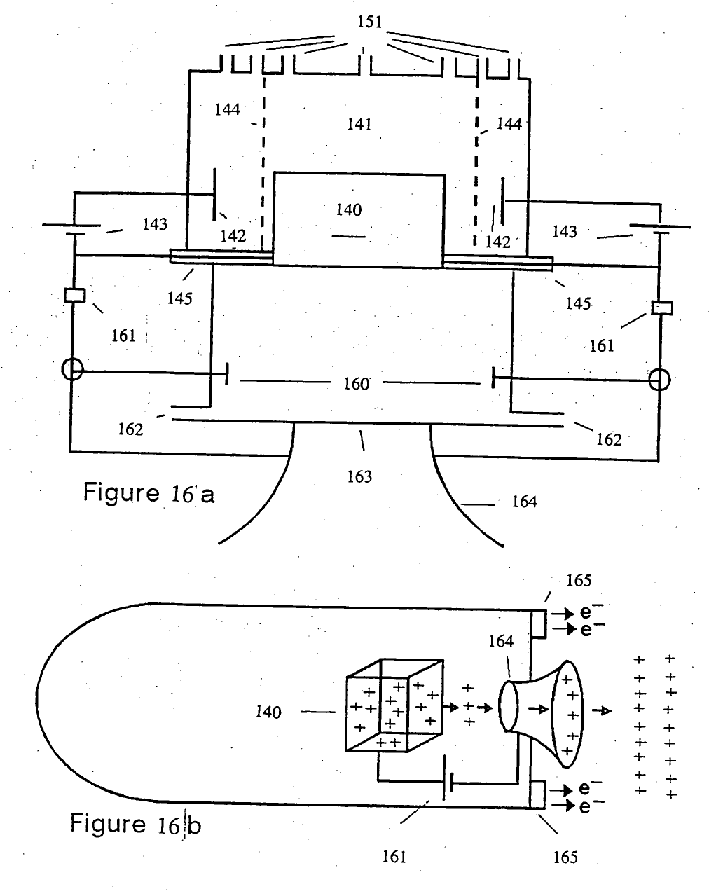

The storage of plasma solid can be a source of energy for jet propulsion. One of the better propellants used to propel rockets is a mixture of liquid hydrogen and oxygen. Liquid hydrogen has a density of 5.4×10²² hydrogen atoms/cm³, and produces energy of 250 kilojoule/mole of H₂. With a plasma solid at a concentration of 4×10²³ protons/cm³ which produces an energy of 3.25×10³ kilojoule/mole of H₂, the energy stored is about a hundred time larger than that of liquid hydrogen. The plasma solid can either be used classically by burning hydrogen with oxygen for jet propulsion, or by only using the energy of recombination (2H⁺+e⁻→R₂), which would obviate the need for oxygen and its costly inefficient mass. But the storage of plasma solid is also a source of matter and electric charge. If the protons depart the cathode under the form of charged particles, they can be accelerated and thus give momentum to a vehicle, such as a rocket. In this case, the loading of plasma solid follows the same principle as the one described in the previous paragraph. The cathode is included between two compartments (FIG. 16).

The first compartment of FIG. 16 is the same as the one described in FIG. 14a. It has the same parts as the one described in the previous paragraphs. The first compartment allows the continuous loading of plasma, and the retention of the plasma inside the electrode through the induction of a state of vibration.

The second compartment has two important functions:
The first function is to keep the plasma inside cathode (140) when there is no use for the plasma. To accomplish this function, electrodes (160) have a positive potential when compared to cathode (140). An ionic solution is used to fill the second compartment so as to control the flow of all particles, and prevent, thanks to the polarity of power source 161, the exit of the plasma.
The second function is to propel the rocket by allowing the protons to leave cathode (140). The ionic solution filling the second compartment is removed with a pump through cavity (162) at the rear of the rocket. Door (163) is opened to establish a contact between the cathode and the vacuum outside the rocket. A high voltage is applied between cathode (140) and exhaust nozzle (164) (positive potential to cathode (140) and negative potential to exhaust nozzle (164)). The polarity difference compels the protons to depart cathode (140). Due to the high voltage, the protons are then expelled at very high speeds, thus propelling the rocket. The flow of protons can be controlled both by adjusting the voltage and by adjusting the free area of the surface of cathode (140) in the second compartment.

To regain control of the plasma solid mechanism, door (163) can be closed and the ionic solution can be reintroduced in the second compartment. The loading polarity is then reestablished. During the emission of H D T⁺ at the rear of the rocket, a separate beam of electrons (165) is ejected to enable the recombination to take place behind the vehicle and prevent the rocket from becoming electrically charged. Such propulsion is interesting because it provides high specific impulse and therefore low propellant consumption. It is reusable, highly efficient, and light of weight. To increase the efficiency, the plasma solid can be created using deuterons.

A system similar to that depicted in FIG. 15b can also be used. The cathode 140 inside the acid solution 141 is one of the cathodes described in FIG. 8 or FIG. 10. The cathodes are cubic, cylindrical, or spherical in shape. The cathodes depicted in FIG. 10 have a cylindrical ring integral with the cathode. The cathodes can be sustained through their centers of gravity of through their vertices or both (e.g., in the case of a cube). The cathode remains constantly in electric contact with the support with no impediment to the vibrations. In zero gravity or weightlessness conditions, the cathode is fixed so as to avoid any movement that removes the cathode from its support. A cubic cathode sustained through all eight of its vertices (FIG. 8G) or through either four or eight of its vertices and through the center of gravity (FIG. 8I) is the most efficient solution. By using those kinds of sustentation, the contact between the cathode and the support remains permanent. The cathode is fixed and can vibrate freely. Depending on the method used to produce the vibrations, a cylindrical ring may be integral with the cathode, i.e., as a one-piece structure. The parts 150 and 153 of FIG. 15b are replaced by door 163 and exhaust nozzle 164 of FIGS. 16a and 16b. When the release of plasma becomes necessary, the ionic solution is completely extracted by use of a pump through hole 155. Then holes 155 and 151 are closed and door 163 is opened. A vacuum is then established inside the cell-containing cathode 140. As in FIGS. 16a and 16b, the application of the same high voltage between the cathode 140 and the exhaust nozzle 164 forces the protons to leave the cathode. The flow of high speed protons propels the rocket. The observations about the ejection of the beam of electrons and about the control of the flow of protons described for the systems corresponding to the FIGS. 16a and 16b remain valid and apply to this alternative system. When the plasma solid is not used as propulsion means, the cathode stores plasma. The cathode continually produces molecular hydrogen. In zero gravity, this hydrogen gas remains mixed inside the ionic solution. This solution is continuously circulated outside the cell in order to separate the gas from the liquid either by centrifugation or other means.

For storage of matter, the plasma solid can also be used to store tritium, which in gaseous form occupies a large volume.

III.C. Creation of a Very Large Intensity

The plasma solid also represents a high density storage of electrical charges. One cubic decimeter of plasma solid at the concentration of 10²³ H⁺.cm⁻³ contains an electrical charge of 10⁷ coulombs in electrons. It is equivalent to ten times the charge contained in a capacitor of one farad charged under a potential of 10⁶ Volt. The opposite charges of the plasma solid can be separated easily by changing the potential of the cathode. This plasma can thus be the source of a very high intensity current in an isolated vehicle such as a car, train, plane, etc. FIG. 15a presents a possible use of this application in a vehicle. When the ionic solution is completely emptied from the second compartment, electrode 153 connected to power source 154 allows the exit of the protons from cathode 140. The flow of electrons passing through power source 154 is equivalent to a high intensity current. The plasma energy communicated to the hydrogen, and combustion energy of the hydrogen burned inside a turbogenerator furnish the electrical energy used by power source 154. Thanks to this energy, it is possible to maintain a current of large amplitude, which can be used to create a magnetic field of large intensity. This field can be used to move or stop a vehicle, or for magnetic levitation, which eliminates the friction of the vehicle with the ground. The same results can be obtained with the system described in FIG. 15b.

III.D. Plasma Solid Fusion

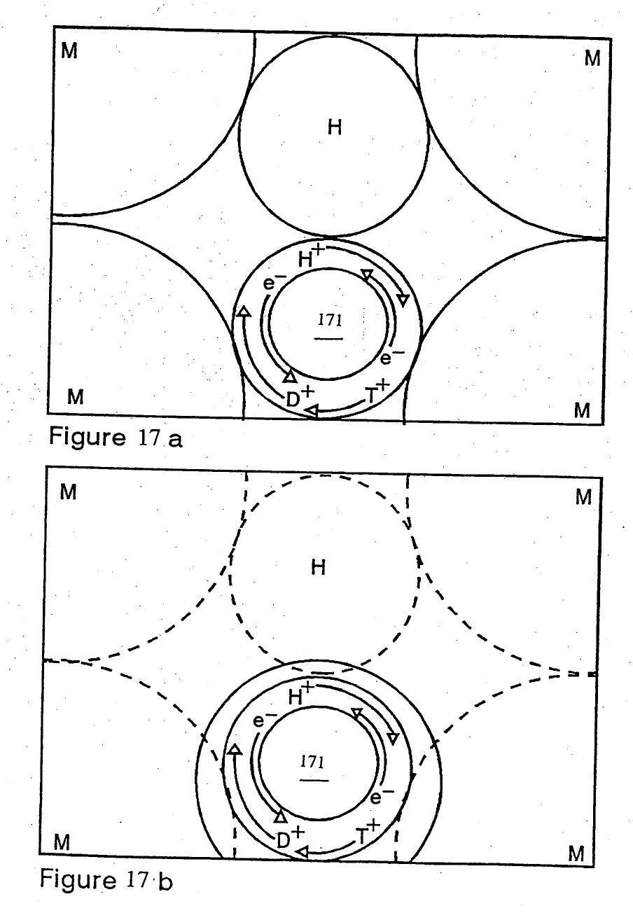

Some of the mechanisms of plasma solid fusion occur at the level of the plasma crown. As an example, FIGS. 17a and 17b present, in a diagonal section of a cube, the plasma crown or nanotokamak as it exists inside an elementary plasma cell. Each vertex is occupied by a metallic atom M. Between the eight atoms of the cubes, inside the free available volume, a hydrogen atom is bound to the metallic structure. The plasma crown 171 occupies the remnant of this volume. This discussion would fully apply in the case of an elementary cell containing no hydrogen atom. FIG. 17b shows the plasma surrounded by the deformed orbitals of the four metallic atoms and of the bound hydrogen atom.

For this application, all the parameters already discussed to create plasma solid remain valid. But the fusion reactions inside the cathode depend on the composition of the plasma solid. To produce the mechanism of plasma solid fusion, the ionic solution contains H⁺, D⁺, or T⁺, or a mixture of two or three of these isotopes. The choice of the reaction will ultimately determine the composition of the solution. Since the penetration of the isotopes inside the electrode will be determined by the respective weight of the isotopes, the composition of the plasma inside the electrode will be different from the composition of the solution. The lighter the isotope, the more easily it will penetrate the electrode. If the experiment entails the loading of a mixture of isotopes, the process can be divided into two steps: the heavier isotopes are loaded first, followed at a second time by the protons whose lesser weight makes them easier to load.

In this very high density plasma solid, these H D T⁺ can react together in three ways to produce fusion reactions. As seen in the previous paragraph, the radius of the spherical plasma crown changes constantly because of the vibrations applied to the plasma. During a compression vibration, the radius of the spherical crown, and the outer surface where the plasma is most likely to be found diminish. If the cell was filled before the increase of the vibration (maximum number of pair proton-electron), the larger compression reduces the outer surface of the spherical crown and causes it to shed one or several pair of proton-electron, which leave the cell to enter plasma crowns located in other plasma cells. In this situation, two cases appear. In the first case, the “plasma crowns” in the cells surrounding the compressed crown are full, the spherical crown can not contain the excess plasma. In these conditions, the plasma concentration becomes too important. Since the plasma can not escape inside the cathode and the protons continue entering the electrode, the plasma cell can break apart (see Schuldiner experiments). In the second case, if the surrounding spherical plasma crowns are not completely filled, the excess plasma from the compressed crown leaves and enters the other spherical crowns. The transfer of plasma occurs through a tridimensional network of channels located between plasma cells. In the case of a cubic plasma cell, the transfer channels are located on each of the six sides of the spherical crown. These channels cross the plane of a cubic face near the center of the square, where it is easier for the electric charges to pass. These channels have the shape of an hourglass: they are larger near the plasma crowns and narrower at the crossing of the cubic face (bottleneck). Because of the vibrations, there is a continuous exchange of plasma between the plasma crowns through the tri-dimensional channels. A plasma crown submitted to a compression wave loses plasma. A plasma crown in expansion is available to receive plasma. When the amplitude of the vibration is large, the transfer occurs very rapidly. The protons, deuterons or tritons, escorted or not by an electron, can collide with another proton, deuteron or triton in two situations:
If two plasma crowns send plasma simultaneously to each other through the same channel, there is a great probability that the protons, deuterons, or tritons will collide at the level of the bottleneck. If the accumulation of energy caused by the stationary waves is sufficient, the H D T⁺ undergo fusion with each other.
When a H D T⁺ particle is sent by a plasma crown toward another plasma crown, its speed diminishes very little until its arrival in the other crown. As seen previously, the electrical field is nil inside and outside the plasma crown because of the electrical neutrality of the plasma and Gauss' law. In this situation, the “plasma crown” is electrically neutral. A H D T⁺ particle moving through a transfer channel will be able to approach the plasma crown without being subjected to any force from the plasma crown. Because of the properties of the crown, the incoming H D T⁺ can get very close to any H D T⁺ of the crown without impediment. When the two H D T⁺ enter the field of nuclear force of the other, they attract one another and undergo fusion. If the H D T⁺ does not meet another H D T⁺ in the first plasma crown, it crosses it without perturbation, and goes on to the next and so on, until it meets another H D T⁺ and fuses. When a plasma crown is compressed, a part of the plasma must be shed so that the plasma crown can retain its electrical balance. The excess plasma transferred can be composed of individual electrical charges emitted in different directions, or of a pair electron-H D T⁺ emitted together. Because of the electrical neutrality of the receiving plasma crown, it is possible to obtain a reaction of nuclear fusion between a H D T⁺ and a H D T⁺-electron pair.

However, the numerous electrons of the metallic atoms impede the motion of the H D T⁺ and the electrons that constitute the plasma between the different plasma cells. The progressive loss of energy during the motion (linear energy transfer) is important. The energy of the H D T⁺ is dampened very quickly. Communicating a large energy by external means to some of the H D T⁺ of the plasma will also help to provoke fusion of H D T⁺ of the plasma. The probability that these highly energetic H D T⁺ will impact and fuse with H D T⁺ of the high density plasma (10²³ to 10²⁴ H D T⁺/cm³ of cathode) during their journey (mm long) is great. The fusion reactions produce one or two highly energetic particles (energy of several Mev), such as neutron, helium ³He²⁺, tritium T⁺, H⁺ . . . . These particles created inside the plasma will then fuse with other H D T⁺ of the plasma. The particles created by the first reaction initiate further reactions. The reactions become self-sustaining (a chain reaction). To trigger the first reaction, the plasma solid is submitted to a large flux of highly energetic neutrons (energy of several Mev). With no electrical charge, these particles can cross the solid of the cathode. During their passage they collide with the H D T⁺ of the plasma and communicate a part of their energy to these particles during each collision: half in the case of a proton, one third in the case of a deuteron and one fourth in the case of a triton. They also collide with the nuclei of the metallic atoms. The mass of the nuclei being much larger than the mass of a simple neutron, the neutron's loss of energy resulting from the collision is small. The energy provided by the neutrons is almost entirely transferred to the free flowing H D T⁺. The source of neutrons can be an intimate mixture of beryllium with an alpha emitting radionuclide as radium 226 or plutonium 238 or americium 241. Californium 252 can be used simply because neutrons are emitted during its spontaneous fission; such a source is particularly compact. These sources of neutrons can have an intensity of about 10¹⁰ neutrons/s. The neutrons provided have an energy of 5 to 6 Mev. The neutron generators can be placed near the cathode so that a neutron reflector can direct the neutrons through the cathode. The neutrons generators are insulated from the acid solution to avoid dissolution. The source of neutrons can also be placed inside the metallic sustaining rod which provides the electric current to the cathode. Since this sustaining rod penetrates inside the cathode, the neutrons appear directly inside the cathode. Adding californium 252 to the material of the cathode could also provide the necessary neutrons. A flux of neutrons coming from a nuclear reactor can also be used as source. Lastly, it is also possible to submit the H D T⁺ of the cathode to a flux of high energy X rays (several Mev).

The chain reaction can be controlled by using several parameters:
Controlling the density of electrons/cm³ of cathode. The choice of the atomic elements constituting the material of the cathode is important. The number of electrons associated to the nuclei will greatly influence the evolution of the reaction. The greater the number of electrons is, the greater the energy loss of the particles H D T⁺ through interaction with these electrons will be. The energy of the particles is dampened quickly and the possibility of fusion disappears. Choosing atomic elements with few electrons (low density of electrons/cm³ in the cathode) enhances the probability of fusion reaction.
Controlling the density of the plasma solid inside the cathode (number of particles/ cm³ of cathode). A large density of particles increases the probability of fusion reactions. The concentration of the plasma solid varies with the current density, the potential applied between anode and cathode, the amplitude of the vibrations of the cathode and the acidity of the solution. By increasing or decreasing the value of these parameters, the concentration of plasma inside the cathode grows or diminishes. The concentration also varies with the size of the plasma cells and therefore, with the nature of the cathode.
Controlling the leaks of neutrons outside of the solid. For a cathode of large volume, all the energy of the neutrons entering into the cathode is lost into the high density plasma of the cathode. The size of the cathode allows the extent of neutron leakage to be controlled.
Controlling the flux of neutrons entering the cathode.

The flux of neutrons into the cathode can be controlled by modifying the distance between the source and the cathode.

Several kinds of reaction are possible:
H on H D on D T on T
H on D D on T
H on T

While all these reactions are possible, some are more interesting when it comes to the production of energy. The composition of the ionic solution will ultimately determine what type of thermonuclear reactions can be realized:
¹H+²H→³He+gamma+5.5 MeV
²H+²H→³He+n+3.3 MeV
²H+²H→³H+¹H+4 MeV
²H+²H→⁴He+gamma+23.8 MeV
¹H+³H→⁴He+gamma+19.8 MeV
²H+³H→⁴He+n+17.6 MeV
²H+³H→+⁵He+gamma+16.7 MeV

Some of the neutrons produced by these reactions escape from the cathode and penetrate into the ionic solution. If the solution contains lithium ⁶Li⁺ ions, the neutrons react with the lithium ions to produce energy and tritium:
⁶Li+n→³H+⁴He+4.96 Mev

Some of the fusion reactions produce ³He⁺⁺. These charged particles trapped inside the solid are used for further fusion reactions:
²H+³He→⁴He+¹H+18.4 Mev

The heat produced by plasma solid fusion can be used directly for domestic purposes such as heating, or for more arcane use such as sea water desalinization. By using a turbogenerator, the heat can also be used to produce electricity. As seen previously in II.B., II.C, and II.E., some alloys can allow the creation of plasma crowns of He²⁺, B⁵⁺, Be⁴⁺, Li³⁺, H D T⁺ or plasma crowns containing any mix of the preceding. With these plasma crowns, some fusion reaction can also be produced:
²H+³He→⁴He+¹H+18.4 MeV
²H+⁴He→⁶Li+gamma+1.5 MeV
¹H+⁶Li→³He+⁴He+4 MeV
²H+⁶Li→2⁴He+22.4 MeV
²H+⁶Li→⁷Li+¹H+5 MeV
²H+⁶Li→⁷Be+n+3.4 MeV
¹H+⁷Li→⁴He+⁴He+17.5 MeV
²H+⁷Li→2⁴He+n+15.1 MeV

III.E. Plasma Solid Fusion Reactor

The methods previously described to produce plasma solid inside the cathodes of the reactor remain valid for this part, including: the shape of the cathodes (e.g., cubic, cylindrical, spherical, etc.), the mode of sustentation through the center of gravity or through the vertices in the case of the cube, production of vibrations through modulated current, magnet or electromagnet, use a self-exciting system, the nature of the cathode, the acid solution, etc. While respecting the conditions presented above, the plasma solid fusion reactor can be designed in two different ways:

The first way makes use of a cathode of large volume. As seen above, because of the volume of the cathode and the density of the plasma, the particles created during the fusion reactions remain inside the cathode. Only neutrons created at the periphery of the cathode can escape from the cathode. The energy which appears inside the volume of the solid can only be dissipated away at the external surface of the solid by the ionic solution. The chain reaction can be controlled by changing the density of the plasma solid either by using the current density, by modifying the amplitude of vibrations at resonance, or modifying the distance between the neutron source and the cathode.

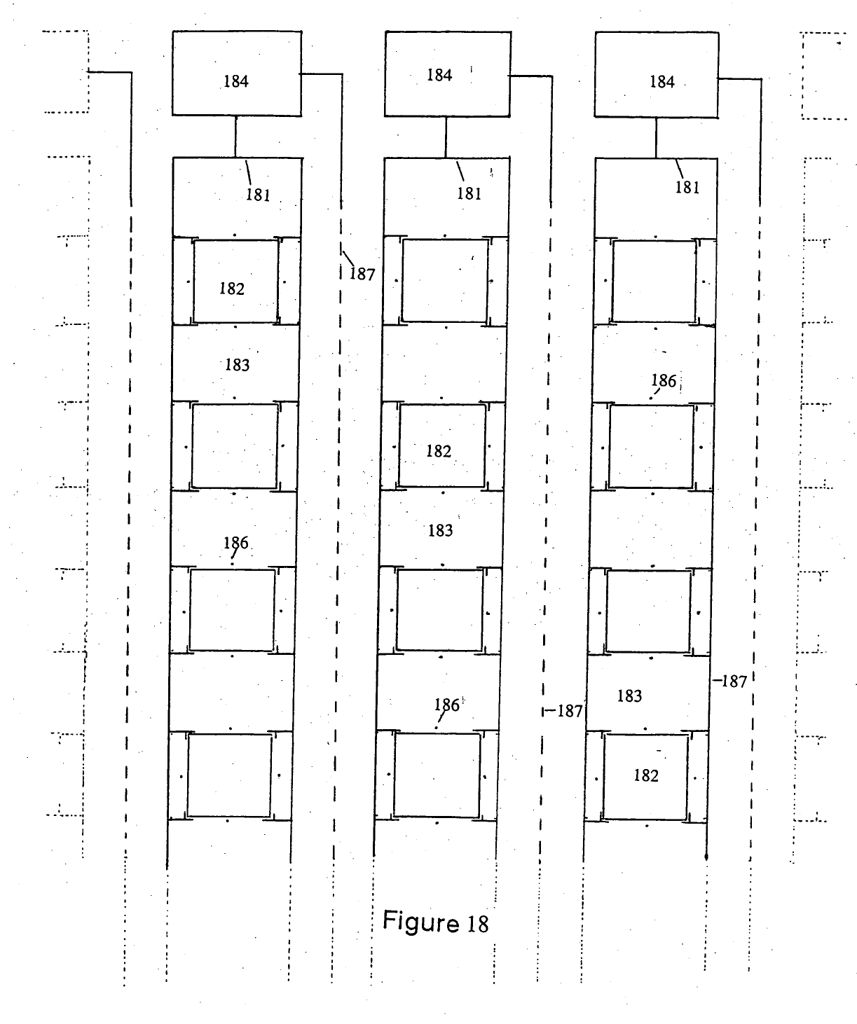

The second way uses a three-dimensional network of multiple cathodes to build a fusion reactor. The use of numerous cathodes allows the production of a large quantity of energy. FIG. 18 presents a two-dimensional cross section of the network, with structures 181 sustaining cathodes 182. FIG. 18 depicts the cathodes as being cubes sustained through their vertices. However the cathodes can be of all the shapes previously described (cube, cylinder, sphere) and every methods of sustentation and vibration production previously described can also be used with this network. Depending on the design, each structure can support either a two- or three-dimensional network of cathodes 182, or a single line of cathodes. When the vibrations are produced by using a magnet or electromagnet, the structures which support the cathode are also used to sustain the magnet. Structures 181 are also used to carry the direct and modulated currents to the cathodes (from the power supply 184). When creating vibrations by using the electromagnetic methods, structures 181 convey the alternative current to the exciting coil through an insulated wire. The entire network is submerged inside ionic solution 183. The solution can be a solution of D₂SO₄ in D₂O, or T₂SO₄ and D₂SO₄ in D₂O and T₂O with ⁶Li₂SO₄. Structures 181 are insulated from contact with the solution by a protective coating. This coating limits the exchange of current to the cathodes. The electric power to cathodes 182 can be supplied either individually to each cathode or collectively either to the group of cathodes of one of the structures or to all the cathodes of all the structures. When the power is supplied to each cathode individually a complete system for controlling of the cathode (power, modulated current, self-exciting system) is necessary for each cathode. When the power is supplied collectively to numerous cathodes on a structure, all the elements of the structure (cathode, system of sustentation, system of excitation, etc.) must be perfectly identical. Since, as seen previously, the resonance phenomenon is very sensitive in frequency, slight differences in the shape, in the size, in the sustentation of the cathode or in the homogeneity of the materials of the cathodes will result in the frequencies of resonance of the cathodes being different from one another. A collective application of power to the cathodes would therefore not result in their being set at the same resonance simultaneously. Control of resonance for each cathode is achieved by using a laser detector (185 as already described). Screens made of unimpeachable material 187 placed between the structures 181 serve as anode.

The source of neutrons 186 placed near each cathode triggers the chain reactions of the fusion reaction. Each neutron penetrating inside the cathode with an energy of several Mev collides with the particles H D T⁺ of the plasma solid. Each neutron transfers its energy to several H D T⁺ of the plasma. In turn, these now highly energized particles react with other H D T⁺ particles. These new collisions can lead to fusion reactions. These fusion reactions each produce one or two new particles such as (³He, n, ³H, ¹H, etc.). These particles have a very high energy (several Mev). Each of these new particles can in turn provoke one or more fusion reaction(s). The chain reaction is dependent on the equilibrium between the energy brought to the cathode by the neutrons and the energy loss of the particles H D T⁺ by the interaction with the electrons of the cathode. The neutrons entering the cathode or those created through fusion reaction can depart the cathode without having lost all their energy inside the cathode. These neutrons pass into the ionic solution which is some centimeters thick between the cathodes. The neutrons can then penetrate again into a new cathode to begin a new chain reaction. Thanks to the limited thickness of the ionic solution located between cathodes, the energy loss of the neutrons during the transfer between cathodes is feeble but depends on this thickness. Shortening or increasing the distance between the cathodes allows the chain reaction to be regulated. This can be achieved by displacing each structure relatively to the other. Increasing the thickness of the ionic solution entails a larger loss of energy for the neutrons during the transfer. The probability that they will be absorbed by an ion ⁶Li⁺ in the solution to produce tritium and energy also increases. Varying the density of the plasma solid inside the cathode by different means previously described is another way to keep or not keep the energy of the neutrons inside the cathode and to control the chain reaction. The energy loss by the H D T⁺ particles which interact with the electrons of the cathode can be minimized by increasing the density of plasma solid and decreasing the density of the electrons of the cathode. This can be achieved by using materials for the cathode with smaller atomic numbers.

The materials used for the cathode, the anode, the structures 181, the electric insulation, and the ionic solution are all neutron absorbers. The elements chosen for these materials preferably have small neutron cross sections. For example, in the case of the ionic solution, the atoms of deuterium, tritium, and oxygen have a small cross section (millibarn). But since the sulfur and chlorine have a large cross section (barn), a sulfur isotope with the smallest neutron cross section possible may be used. This isotope S³³ has a cross section measured in millibarn. It can be used to make sulfuric acid. To attain good operation of the fusion reactor, all of the elements of the materials used to build the device are preferably made of isotopes with the smallest cross section possible. These materials are also pure. Impurities with large neutron cross sections, like boron, cadmium, and the like will dampen the process.

The ionic solution flows between the cathodes in the same direction continually. The energy created inside the cathodes is carried away to the turbine of the fusion reactor.

III.F. By-Products of Plasma Solid Fusion

The reaction of plasma solid fusion produces by-products, including particles alpha, gamma, and neutrons. The plasma solid fusion can also be a source of tritium and Helium ³He. Two deuterons react inside the cathode by plasma solid fusion D (d,p) T and produce one triton. Inside the layer the triton can react electrochemically with a proton, a deuteron or another triton to form molecular hydrogen (HT, DT, or TT), which then departs the electrode. The tritium can thus be recuperated, by collecting the hydrogen gases, for other utilization, or reinjected in the solution. The tritium produced during this first reaction react with a deuteron to produce Helium:
²H+³H→⁴He+n+17.6 MeV

The neutrons can be produced in other plasma solid reactions. These neutrons then react with ⁶Li⁺ ions inside the ionic solution to produce tritium:
⁶Li+n→³H+⁴He+4.96 MeV

The neutrons can also react with the metallic nuclei to produce isotopes of the atoms of the cathode.

As seen previously, the fusion reactions also produces ³He. This element is very useful for nuclear reaction.

III.G. Transmutation

The fusion reactions create different kinds of particles (protons, tritons, neutrons, helium, ³He and ⁴He). These particles have energies of several Mev. The neutrons produced by these reactions can communicate their energy to the H D T⁺ of the plasma solid. If the H D T⁺ then collides with enough energy with one of the metallic nucleus, they can undergo fusion with the metal atom and provoke a transmutation. If there is no stripping during the fusion reaction, the interaction between the three different isotopes and a metallic atom M can have three different outcomes:
ₓM^{y}+₁H¹→ₓ₊₁M^{y+1}
ₓM^{y}+₁D²→ₓ₊₁M^{y+2}
ₓM^{y}+₁T³→ₓ₊₁M^{y+}³

Since it is possible to use all the metallic elements directly or in more efficient alloys duplicating the properties of palladium to create plasma solid, this transmutation method can be applied to numerous elements. Among other applications, it can be used to convert radioactive elements (⁹⁰Sr, ⁵⁵Fe, ⁵⁹Ni, ⁹⁴Nb, ⁹⁹Tc, . . . ) into stable elements. The following transmutations are possible:
⁵⁵Fe+₁H¹→⁵⁶Co (78.8 days)→⁵⁶Fe_{stable}+beta⁺
⁵⁹Ni+₁H¹→⁶⁰Cu→⁶⁰ Ni_{stable}+beta⁺
⁹⁴Nb+₁H¹→⁹⁵MO_{stable}
⁹⁹Tc+₁H²→¹⁰¹Ru_{stable}
⁹⁰Sr+₁H¹→⁹¹Y(57 days)→⁹¹Zr_{stable}+beta⁻

This process can be used to destroy long lasting radioactive elements. They can be converted into radioactive elements with short half-times and then into stable elements. This method could help resolve the problem posed by the accumulation of long lasting radioactive nuclear wastes. This method of transmutation can also be used to create scarce elements which have a specific value: as the isomer Hf^{178m2} which has a half life of 31 years. It also can be used to create radioactive elements with interesting medical properties. Fissile elements can be produced by transmutation (such as uranium 233 from thorium 232 or plutonium 239 from uranium 238).

For all these elements, the structure of the metal or of the alloy only suffers minor modification after the transmutation since the elements created are of about the same size as the elements they replaced. Primarily, the method can be used to produce energy. The creation of the rare elements or the transmutation of radioactive elements will occur as a byproduct of the reaction inside the cathode. Transmutations also occur when the neutrons interact with the nuclei of the cathode. The capture of a neutron by a nucleus can produce an unstable isotope. Nuclear transformations follow and produce different elements.

III.H. Energy Wave

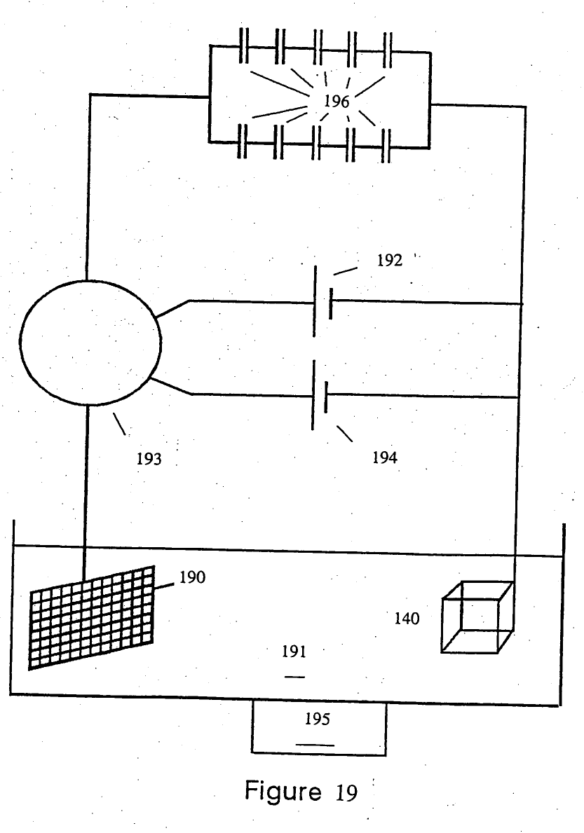

The objective is to send, instantaneously, a large amount of protons inside a cathode already loaded with plasma solid (concentration of 10²³ to 10²⁴ H D T⁺ per cm³). This can be realized by applying a high voltage to the solution. However, since the resistance of the bath is too low (some tenths of an ohm), the high voltage can only be applied by using the discharge of a series of capacitors (FIG. 19). To allow the energy wave to concentrate at the center of the cathode, cathode 140 will preferably be of spherical or cylindrical shape. The size of the cathode will depend of the desired effect. The concentric shape of the cathode allows a very large compression of the plasma at the center of the cathode. Anode 190 is a platinum screen designed to avoid the creation of an upper limit to the amount of current that can pass through the anode. The ionic solution 191 can be a mixture of protons and deuterons (DCl+HCl or D₂SO₄+H₂SO₄ in D₂O and H₂O) or a pure solution of deuterons (D₂SO₄ in D₂O) or a mixture of deuterons and tritons (D₂SO₄ in D₂O and T₂O). These solutions are very acid and have a concentration of 10²¹ H D T⁺.cm⁻³ or more. Power source 194, a combination of direct and pulsed current, allows the creation and storage of plasma solid. The discharge lasts about one second. To avoid the problem of diffusion at the cathode, the solution should be agitated [195] in the bath at a high speed. The serial and parallel combination of the capacitors 196, allows a capacity of approximately one Farad or more to be obtained. These capacitors can then be charged under a 1000 volts voltage 192. The capacitors can accumulate an electric charge of a thousand Coulombs or the equivalent of 6×10²¹ electrons and an energy of 5×10⁵ joules. When the capacitors are connected by 193, they discharge in the bath. The energy is divided entirely between the ions of the solution. The 6×10²¹ protons which enter the cathode bring with them a large energy. This energy driven compression of the plasma solid can result in some of the following reactions (or others):
H (D, He) gamma (5.4 MeV)
D (D, He) n (3.3 MeV)
D (D, T) H (4 MeV)

If the plasma is only composed of deuteron, it is possible to create a large impulse of neutrons. The effect can be improved and augmented by the concentric shape of the cathode.

The energy entering the cathode penetrates a layer some microns deep. This energy density is very large and melts parts of the metal which make up the cathode.

The method can be used to realize a thermal process of the surface of the cathode. This large energy wave method can be used with other ions in the ionic solution or in gaseous plasma. Numerous ions have a radius smaller than 1 Angstrom (Li⁺, Be²⁺, Mg²⁺, Na⁺, Ti²⁺, Cr³⁺, Mn²⁺, Fe³⁺, Ni²⁺, Cu²⁺, Zn²⁺, etc.). In aqueous solutions, these ions are solvated by several molecules of water. When high voltage is applied, these ions lose the molecules of water, and are precipitated violently on the cathode. At these speeds, the layer of plasma inside the cathode acts as a wall. These ions collide with the H D T⁺ of the plasma at very high speeds, and produce different kind of nuclear reactions. For example, the ions Li⁺ can react:
²H+⁶Li→2⁴He+22.4 MeV
²H+⁶Li→⁷Li+¹H+5 MeV
²H+⁶Li→⁷Be+n+3.4 MeV
²H+⁷Li→2⁴He+n+15.1 MeV

These nuclear reactions, depending of the ions and hydrogen isotopes used, can produce energy, radioactive isotopes, particles, etc.

III.I Target

The plasma solid can be used as a target inside an accelerator. The plasma inside the cathode represent a wall for the ions accelerated toward this target. Many nuclear reactions are possible. It can also serve as a target for multiple laser beams to provoke fusion reactions inside the cathode.

Additional advantages and modifications will readily occur to those skilled in the art. Therefore, the invention in its broader aspects is not limited to the specific details, representative devices and methods, and illustrative examples shown and described. Accordingly, departures may be made from such details without departing from the spirit or scope of the general inventive concept as defined by the appended claims and their equivalents.

### PUBLICATIONS

[1] A. Paets van Troostwyk and J. R Deiman, Observation sur la physique, sur l'histoire naturelle et sur les arts (journal de physique, . . . ) Paris, Vol. 35, Part II, 369, November 1789.
[2] A. Carlisle and W. Nicholson, Journal of Natural Philosophy, Chemistry and the Arts (Nicholson's Journal), Vol 4, 179, 1801.
[3] R. Clamroth and C. A. Knorr, Z. Electrochem., 57, 399, 1953.
[4] J. P. Hoare and S. Schuldiner, J. Electrochem. Soc, 102, 485, 1955.

What is claimed is:

1. A method of producing a stable plasma inside a solid, comprising:
providing a source of ionic particles selected from the group consisting of an ionic solution having a pH less than 1.0, plasma gas, and a gas atmosphere;
supporting a solid with a support;
applying a direct electrical current to the solid through the support;
introducing the ionic particles from the source of ionic particles into the solid to form a plasma; and
applying periodic impulses to the solid to vibrate the solid and stabilize the plasma.

2. A method according to claim 1, wherein:
the solid has a resonance frequency at which the solid vibrates at a maximum amplitude; and
said applying comprises applying the periodic impulses to vibrate the solid at the resonance frequency.

3. A method according to claim 2, wherein the vibrations have an amplitude and a frequency, and wherein the method further comprises monitoring the amplitude and the frequency to synchronize the periodic impulses with the resonance frequency of the solid.

4. A method according to claim 1, wherein:
the solid has a resonance frequency at which the solid vibrates at a maximum amplitude; and
said applying comprises applying the periodic impulses to vibrate the solid at a frequency sufficiently close the resonance frequency to produce an amplitude of vibration that is at least one-fifth the maximum amplitude.

5. A method according to claim 1, wherein the solid comprises palladium.

6. A method according to claim 1, wherein the solid comprises an element or alloy without an affinity to hydrogen and having an average apparent atomic volume less than 11.1 cubic angstroms.

7. A method according to claim 1, wherein the solid comprises an element or alloy with an affinity to hydrogen and having an average apparent atomic volume in at least one range selected from 13.8 to 16.8 cubic angstroms, 20 to 22.5 cubic angstroms, and about 30 cubic angstroms.

8. A method according to claim 1, wherein the cathode is symmetrical and has a shape selected from the group of cubic, cylindrical, and spherical.

9. A method according to claim 1, wherein the source of particles comprises the ionic solution, and wherein the plasma comprises at least one member selected from protons, deuterons, and tritons.

10. A method according to claim 9, wherein said applying a direct electrical current comprises imparting a current density of at least 50 mA/cm² to the solid.

11. A method according to claim 10, wherein the plasma has a density of 10²² to 10²⁴ particles of protons, deuterons, and/or tritons per cubic centimeter inside the solid.

12. A method according to claim 11, further comprising applying the direct electrical current and the periodic impulses through the support.

13. A method according to claim 12, wherein the solid has a center of gravity at which the support supports the solid.

14. A method according to claim 12, wherein the solid has vertices at which the support supports the solid.

15. A method according to claim 12, wherein said applying periodic impulses comprises applying a pulsed current to the solid by carrying the pulsed current through the support.

16. A method according to claim 15, wherein the solid has a center of gravity at which the support supports the solid.

17. A method according to claim 1, wherein said applying periodic impulses comprises applying an electrodynamic current to the solid.

18. A method according to claim 17, wherein the solid has a center of gravity at which the support supports the solid.

19. A method according to claim 17, wherein electrodynamic device comprises:
a magnetic member selected from a magnet and an electromagnet, the magnetic member comprising a central pole made of laminated metal, the central pole having a periphery;
a coil at the periphery of the central pole for creating an alternative magnetic field;
insulation covering the magnetic member and the coil for electrically isolating the magnetic member and the coil from the support and the ionic solution; and
at least one passage for allowing the ionic solution to flow through the magnetic member.

20. A method according to claim 19, wherein the solid further comprises a cylindrical ring extending from a surface of the solid and in the ionic solution, the cylindrical ring and the solid being integral with one another.

21. A method according to claim 1, wherein said applying periodic impulses comprises applying a magnetic field and a superposed alternative magnetic field to the cathode.

22. A method according to claim 21, wherein the solid has a center of gravity at which the support supports the solid.

23. A method according to claim 1, wherein said applying of periodic impulses is performed with an electrodynamic device comprising:
a magnetic member selected from a magnet and an electromagnet, the magnetic member comprising a central pole made of laminated metal, the central pole having a periphery;
a coil at the periphery of the central pole for creating an alternative magnetic field;
insulation covering the magnetic member and the coil for electrically isolating the magnetic member and the coil from the support and the ionic solution; and
at least one passage for allowing the ionic solution to flow through the magnetic member.

24. A method according to claim 23, wherein the solid further comprises a cylindrical ring extending from a surface of the solid and in the ionic solution, the cylindrical ring and the solid being integral with one another.

25. A method according to claim 1, further comprising affixing a quartz or magnetostriction transducer to the solid.

26. A method according to claim 1, wherein the source of particles comprises the plasma gas.

27. A method according to claim 26, wherein the plasma gas comprises ionic particles selected from protons, deuterons, and tritons.

28. A method according to claim 26, wherein the plasma gas comprises ionic particles other than protons, deuterons, and tritons, and further wherein the plasma gas optionally further comprises protons, deuterons, and tritons.

29. A method according to claim 26, wherein said applying a direct electrical current comprises imparting a current density of at least 50 mA/cm² to the solid.

30. A method according to claim 26, wherein the plasma has a density of 10²² to 10²⁴ particles of protons, deuterons, and/or tritons per cubic centimeter inside the solid.

31. A method according to claim 26, further comprising:
supporting the solid with a support;
applying the direct electrical current and the periodic impulses through the support.

32. A method according to claim 31, wherein the solid has a center of gravity at which the support supports the solid.

33. A method according to claim 31, wherein the solid has vertices at which the support supports the solid.

34. A method according to claim 31, wherein said applying periodic impulses comprises applying a pulsed current to the solid by carrying the pulsed current through the support.

35. A method according to claim 34, wherein the solid has a center of gravity at which the support supports the solid.

36. A method according to claim 31, wherein said applying periodic impulses comprises applying an electrodynamic current to the solid.

37. A method according to claim 36, wherein the solid has a center of gravity at which the support supports the solid.

38. A method according to claim 36, wherein electrodynamic device comprises:
a magnetic member selected from a magnet and an electromagnet, the magnetic member comprising a central pole made of laminated metal, the central pole having a periphery;
a coil at the periphery of the central pole for creating an alternative magnetic field;
insulation covering the magnetic member and the coil for electrically isolating the magnetic member and the coil from the support; and
at least one passage for allowing the plasma gas to flow through the magnetic member.

39. A method according to claim 38, wherein the solid further comprises a cylindrical ring extending from a surface of the solid, the cylindrical ring and the solid being integral with one another.

40. A method according to claim 31, wherein said applying periodic impulses comprises applying a magnetic field and a superposed alternative magnetic field to the solid.

41. A method according to claim 40, wherein the solid has a center of gravity at which the support supports the solid.

42. A method according to claim 31, wherein said applying of periodic impulses is performed with an electrodynamic device comprising:
a magnetic member selected from a magnet and an electromagnet, the magnetic member comprising a central pole made of laminated metal, the central pole having a periphery;
a coil at the periphery of the central pole for creating an alternative magnetic field;
insulation covering the magnetic member and the coil for electrically isolating the magnetic member and the coil from the support; and
at least one passage for allowing the plasma gas to flow through the magnetic member.

43. A method according to claim 42, wherein the solid further comprises a cylindrical ring extending from a surface of the solid, the cylindrical ring and the solid being integral with one another.

44. A method according to claim 31, further comprising affixing a quartz or magnetostriction transducer to the solid.

45. A method according to claim 1, wherein the source of particles comprises the gas atmosphere, the gas atmosphere comprising hydrogen.

46. A method according to claim 45, wherein said applying a direct electrical current comprises imparting a current density of at least 50 mA/cm² to the solid.

47. A method according to claim 45, wherein the plasma has a density of 10²² to 10²⁴ particles of protons, deuterons, and/or tritons per cubic centimeter inside the solid.

48. A method according to claim 45, further comprising:
supporting the solid with a support; and
applying the direct electrical current and the periodic impulses through the support.

49. A method according to claim 48, wherein the solid has a center of gravity at which the support supports the solid.

50. A method according to claim 48, wherein the solid has vertices at which the support supports the solid.

51. A method according to claim 48, wherein said applying periodic impulses comprises applying a pulsed current to the solid by carrying the pulsed current through the support.

52. A method according to claim 51, wherein the solid has a center of gravity at which the support supports the solid.

53. A method according to claim 48, wherein said applying periodic impulses comprises applying an electrodynamic current to the solid.

54. A method according to claim 53, wherein the solid has a center of gravity at which the support supports the solid.

55. A method according to claim 53, wherein electrodynamic device comprises:
a magnetic member selected from a magnet and an electromagnet, the magnetic member comprising a central pole made of laminated metal, the central pole having a periphery;
a coil at the periphery of the central pole for creating an alternative magnetic field;
insulation covering the magnetic member and the coil for electrically isolating the magnetic member and the coil from the support; and
at least one passage for allowing the hydrogen gas to flow through the magnetic member.

56. A method according to claim 55, wherein the solid further comprises a cylindrical ring extending from a surface of the solid, the cylindrical ring and the solid being integral with one another.

57. A method according to claim 48, wherein said applying periodic impulses comprises applying a magnetic field and a superposed alternative magnetic field to the solid.

58. A method according to claim 57, wherein the solid has a center of gravity at which the support supports the solid.

59. A method according to claim 48, wherein said applying of periodic impulses is performed with an electrodynamic device comprising:
a magnetic member selected from a magnet and an electromagnet, the magnetic member comprising a central pole made of laminated metal, the central pole having a periphery;
a coil at the periphery of the central pole for creating an alternative magnetic field;
insulation covering the magnetic member and the coil for electrically isolating the magnetic member and the coil from the support; and
at least one passage for allowing the hydrogen gas to flow through the magnetic member.

60. A method according to claim 59, wherein the solid further comprises a cylindrical ring extending from a surface of the solid, the cylindrical ring and the solid being integral with one another.

61. A method according to claim 48, further comprising affixing a quartz or magnetostriction transducer to the solid.

62. A method according to claim 1, further comprising:
providing an anode having an available surface area;
altering the available surface area of the anode.

63. A method according to claim 1, wherein the solid comprises elementary plasma cells and elementary energy cells, the elementary plasma cells sized to allow the formation and retention of the stable plasma therein, the elementary energy cells sized to allow the formation of hydrogen molecules therein for producing energy to vibrate the solid at the resonance frequency.

64. An apparatus for producing a stable plasma, comprising:
a solid material constructed to permit the creation of stable plasma therein;
a source of ionic particles selected from the group consisting of an ionic solution having a pH less than 1.0, plasma gas, and a gas atmosphere;
means for applying a direct electrical current to a solid;
means for applying periodic impulses to the solid to vibrate the solid and stabilize the plasma.

65. A method of producing a stable plasma in a solid and using the plasma, comprising:
providing a source of ionic particles selected from the group consisting of an ionic solution having a pH less than 1.0, plasma gas, and a gas atmosphere;
applying a direct electrical current to a solid;
introducing the ionic particles from the source of ionic particles into the solid to form a plasma;
applying periodic impulses to the solid to vibrate the solid and stabilize the plasma; and
using the plasma.
